(19) United States
(12) Patent Application Publication
(10) Pub. No.: US 2026/0295903 A1
(43) Pub. Date: Oct. 1, 2026

(54) METHODS FOR PREPARING FIBER-CONTAINING PARTICLES WITH RECYCLED REINFORCING FIBERS

(71) Applicant: Vartega Inc., Denver, CO (US)

(72) Inventors: Kylie Marie Van Aken, Reno, NV (US); Sean Paul Kline, Arvada, CO (US); Andrew Timothy Maxey, Arvada, CO (US); Sean Louis Hankins, Jacksonville, FL (US); Angelique Whalen Kenison, Arvada, CO (US); Jordan Gray Harris, Arvada, CO (US)

(21) Appl. No.: 19/480,320

(22) PCT Filed: Apr. 30, 2024
(86) PCT No.: PCT/US2024/027057

§ 371 Date: Oct. 30, 2025

Related U.S. Application Data
(60) Provisional application No. 63/463,812, filed on May 3, 2023.

(51) Int. Cl. B29B 9/14; B29C 70/14; B29K 307/04

(52) U.S. Cl. CPC B29B 9/14; B29C 70/14; B29K 2307/04

(57) ABSTRACT

Recycled carbon fibers in non-continuous form are processed by rotational tumbling in a mixture with binder material to prepare fiber-containing agglomerates. Preliminary processing options include alignment of recycled non-continuous fibers in recycled fiber feed, non-continuous fiber length reduction following alignment, and fiber size classification to remove oversize non-continuous fibers prior to tumbling. Subsequent processing can include size classification of agglomerates and reprocessing of oversize agglomerates.

### CROSS-REFERENCE

This application claims benefit of U.S. provisional patent application No. 63/463,813 filed May 3, 2023 entitled “METHODS OF PREPARING FIBER-CONTAINING PARTICLES WITH RECYCLED REINFORCING FIBERS”, each and every portion of which is incorporated by reference herein, for all purposes.

This application incorporates by reference, for all purposes, each and every portion of U.S. patent application Ser. No. 17/674,089 filed Feb. 22, 2022 (and corresponding issued U.S. Pat. No. 11,787,085) entitled “METHODS OF MAKING AND USING BULK PRODUCTS INCLUDING FIBER-CONTAINING PARTICLES WITH DUAL-TAPERED SHAPE”, U.S. patent application Ser. No. 18/222,380 filed Jul. 14, 2023 (and corresponding issued U.S. Pat. No. 11,951,656) entitled “FIBER-CONTAINING PARTICLES WITH DUAL-TAPERED SHAPE”, and international patent application no. PCT/US2021/057389 filed Oct. 29, 2021 (and corresponding international patent publication WO 2023/075795 A1) entitled “FIBER-CONTAINING PARTICLES WITH DUAL-TAPERED SHAPE”.

### FIELD

The invention relates to processing reinforcing fibers, and especially recycled carbon fibers, into fiber-containing particles, including methods of preparing the particles, bulk products including the particles and methods of use to prepare fiber-reinforced composites.

### BACKGROUND

Carbon and other fibers are used in a variety of reinforcing applications in which the fibers are combined with a matrix, often a polymeric matrix, to provide reinforcement to the matrix material and to provide enhanced material properties. A composite material of fiber-reinforced polymer is sometimes referred to generally by the acronym FRP and a composite material of carbon fiber-reinforced polymer is sometimes referred to by the acronym CFRP. The commercial value of reinforcing fibers and environmental and landfill considerations have created significant interest in development of processes to recover and recycle reinforcing fibers for reuse. This is especially the case for carbon fibers, as virgin carbon fibers have a high cost. A significant amount of CFRP that is produced is never used and ends up as waste. For example, it is common in CFRP applications for material trim and scrap waste to amount to about 30% or more of finished part weight. Additionally, the amount of CFRP products has been growing rapidly for several years and there is expected to be a rapidly growing need to address end-of-life issues for CFRP products.

CFRP composites as possible feed to recycling operations come in a variety of forms and compositions. Some CFRP composites available as feed to recycling are in the form of prepreg including a matrix of thermoset polymer resin, while other composites available as feed to recycling are in the form of cured products in which a thermoset polymer resin has been cured to form a cross-linked matrix. Yet other CFRP composites available for feed to recycling include a matrix of thermoplastic polymer, and emerging CFRP composites are being developed with engineered polymers that do not neatly categorize as either thermoplastic or thermoset.

Various different processes have been developed and continue to be developed to free carbon fibers from the matrix in CFRP products to permit recovery of the freed fibers for recycling. Some processing techniques to free carbon fibers from matrix, sometimes referred to as pyrolysis, subject the CFRP to high temperatures, typically in an oxygen-free or oxygen-limited environment, to decompose the matrix to gaseous and/or liquid decomposition products without destroying the carbon fibers. Other processing techniques, sometimes referred to as depolymerization techniques, use chemical agents to react with and break down material of the matrix into decomposition products, from which the fibers may be separated. Other processing techniques, sometimes referred to as solvolysis techniques, use a solvent to dissolve away material of the matrix to free the fibers for recovery. Some processes may use a combination of these techniques.

Whereas virgin carbon fiber is typically prepared in the form of continuous fiber strands, the bulk of recycled carbon fibers is currently, and is expected to continue to be available, primarily in a form of non-continuous, relatively short fibers and with significant randomness in fiber orientation and intertwining of individual fibers. One common technique to prepare virgin carbon fibers for incorporation into CFRP composites is to prepare a bound bundle of parallel continuous fiber strands, such as in the form of a fiber tow, and to cut the bound continuous bundle into pellets of a desired length. The fibers may be held in the bundle by fiber sizing previously applied to the bundle (e.g., sized tow). Pellets prepared by chopping fiber tow bundles may be referred to as chopped tow pellets. Such pellets may be prepared with a size and shape for convenient feed to a compounding extruder, for example from a hopper into a side feeder to a twin screw extruder. A common side feeder has a feed screw that positively pushes the pellets into polymer melt in the extrusion barrel. The extrudate including the polymer and carbon fibers may then be cooled and cut into pellets of CFRP material. These pellets may be used for various applications, such as injection molding, to prepare various product forms made of CFRP composite. The ability to process the virgin carbon fibers in the form of a bundle of continuous fiber strands permits tight process control to prepare pellets of uniform size and In the composition and with good properties of flowability during bulk handling and good dispersibility of fibers in polymer melt during compounding. These techniques for processing virgin carbon fibers are generally not applicable, however, to processing of the great majority of recycled carbon fibers, which after recovery during recycling operations tend to be in a non-continuous form and with significant randomness in orientation of the carbon fibers.

Moreover, feedstocks of recycled carbon fibers can have highly variable properties. Unlike the controlled feedstock qualities of virgin carbon fibers, feedstocks of recycled carbon fibers can have a high degree of variability, for example as a consequence of differences in composite waste and scrap from which the recycled carbon fibers are recovered, differences in processing technique used to recover carbon fibers from such composite waste and scrap, and differences in handling of recycled carbon fibers following recovery. Accordingly, feedstocks of recycled carbon fibers can vary significantly, for example, in terms of degree of randomness of fiber orientation, degree of bending, bundling and intertwining of fibers and degree of variability in lengths of fibers.

There is a significant need for alternative and more versatile techniques to those employed to process virgin carbon fiber feedstocks that will permit wider use of the variable feedstocks of recycled carbon fibers to prepare CFRP composites.

### SUMMARY

As noted, recycled carbon fibers are typically recovered as relatively short, non-continuous fiber lengths, with a high degree of randomness in fiber orientation and with significant fiber intertwining, and tend to form cotton ball-like clumps that are not amenable to effective handling and processing with conventional equipment and techniques designed for use with flowable powders and other bulk materials. Recycled carbon fibers have a high tendency, for example, to stick together in clumps and form bridges that block flow from hoppers into feeders to compounding extruders.

Attempts to employ traditional pellet milling to prepare masterbatch pellets with recycled carbon fibers mixed with polymer were of limited success. Recycled carbon fibers resulted in only marginally functional masterbatch pellets which could only be successfully compounded with polymer when the recycled fibers were milled down to a size of approximately 150 microns. As may be appreciated, longer fibers, with a higher aspect ratio, are desirable for enhanced performance as a polymer reinforcement. However, masterbatch pellets made with longer recycled fibers were found to provide poor mechanical performance for polymer compounding. The pellets were found to be too dense to permit effective disintegration and dispersion of the carbon fibers during extrusion processing to form a CFRP composite, which resulted in inconsistent fiber loading in injection molded test forms.

The methods and products disclosed herein are intended to at least partially address in a significant way problems associated with incorporating recycled carbon fibers into CFRP composites and making molded products from such CFRP composites. Although the methods and products disclosed herein are described primarily with reference to carbon fibers, the disclosure applies also to other reinforcing fibers, including other recycled fibers. Also, the methods and products disclosed herein are also applicable to processing virgin fibers that are processed in the form of relatively short fibers rather than in a continuous form. Such virgin fibers in non-continuous form may be a direct result of a manufacturing process and/or may be fibers cut from continuous fiber strands. The methods and products disclosed herein are particularly advantageous for use with recycled reinforcing fibers, such as recycled carbon fibers, which are typically recovered in a non-continuous fiber form and with a high degree of randomness of fiber orientation and fiber intertwining, which makes subsequent processing of the recycled fibers difficult to prepare fiber-reinforced polymers using the recycled fibers.

It has been found that recycled reinforcing fibers (e.g., carbon fibers) having a high degree of randomness in longitudinal orientation of the fibers can be processed into agglomerated bundles having a particle structure, referred to herein as “agglomerates”, by processing including tumbling non-continuous recycled fibers in a process mixture with binder material, and typically also including liquid (e.g., water) at a controlled level, until the agglomerates are formed during the tumbling. The agglomerates can then be recovered and further processed to prepare final fiber-containing particles, typically in a dried particle form, for a high-quality bulk product suitable for use as feed in polymer compounding applications to prepare fiber-reinforced composites with the recycled reinforcing fibers.

This processing can advantageously be used to prepare fiber-containing particles including the reinforcing fibers bound in an elongated particle structure, and with many particles prepared advantageously having a dual-tapered shape. Such a fiber-containing particle may comprise:
a major portion by weight, and preferably from 90 weight percent to 99.5 weight percent, of reinforcing fibers;
a minor portion by weight, and preferably from 0.5 weight percent to 10 weight percent, of binder holding the reinforcing fibers in the particle structure;
a particle length dimension, preferably in a range of from 3 millimeters to 40 millimeters, being a maximum separation distance in a longitudinal direction between first and second longitudinal ends of the fiber-containing particle;
a maximum particle width dimension transverse to the longitudinal direction at a longitudinal location between the first and second longitudinal ends; and
an aspect ratio equal to the particle length dimension divided by the maximum particle width dimension that is larger than 1, and preferably is at least 1.5.

Many of the elongated particles may also advantageously be prepared having a dual-tapered shape comprising a first tapered portion tapering in the longitudinal direction away from the longitudinal location toward the first longitudinal end and a second tapered portion tapering in the longitudinal direction away from the longitudinal location toward the second longitudinal end.

Such fiber-containing particles having a dual-tapered shape prepared with recycled carbon fibers have been found to promote flowability of bulk products with the fiber-containing particles for feeding to compounding extruders through extrusion feeders supplied from conventional hoppers, for example from vibratory loss-in-weight hoppers, to prepare carbon fiber-reinforced polymer composites including carbon reinforcing fibers provided by the fiber-containing particles dispersed in a polymeric matrix. The fiber-containing particles provide an advantageous combination of reasonable flowability for bulk product handling and maintenance of sufficient particle integrity during normal handling and processing operations up to and through a feed hopper during compounding operations, and then degrading from the particle structure due to shear exerted in side screw feeders to an extruder barrel and in polymer melt during extrusion processing to provide an extrudate with reinforcing fibers reasonably well dispersed in the extruded polymer. The dual-taper particle structure permits convenient incorporation of fibers of varying lengths into the fiber-containing particles for beneficial use of a range of fiber lengths in fiber reinforcing applications. Moreover, the dual-taper shape is characteristic of a significant degree of longitudinal alignment of fibers with the longitudinal direction of the fiber-containing particles, which is believed to significantly contribute to the development of enhanced flowability in bulk product form and enhanced dispersibility of the fibers from the particles into polymer melt during polymer compounding to prepare fiber-reinforced polymer composites. Achievement of such a significant degree of fiber alignment significantly reduces the randomness of fiber orientation, which has a significant benefit of reducing protrusions of fibers from the fiber-containing particles perpendicular to the longitudinal direction, which reduces inter-particle entanglements that could impair bulk product flowability. Rather, the dual-taper shape and the characteristic significant alignment of fibers with the longitudinal direction of the fiber-containing particles facilitates gliding of the fiber-containing particles in a bulk product, contributing to flowability and generally imparting glidant properties to the bulk product, even when the fiber-containing particles with the dual-taper shape are mixed with other particles in a bulk product. With respect to dispersibility of fibers into polymer melt during polymer compounding, the significant alignment of fibers in the dual-taper shape of the fiber-containing particles promotes reduced entanglement of fibers as the particles degrade during polymer compounding, facilitating enhanced dispersibility of the fibers into polymer melt during polymer compounding, for example in an extruder.

The fiber-containing particles prepared by the methods of the present disclosure can advantageously be used to prepare bulk products comprising a plurality of fiber-containing particles, and preferably with the bulk product being comprised of some, and preferably a significant portion, of fiber-containing particles having the dual-tapered shape. Such a bulk product may or may not also include other particles in addition to the fiber-containing particles with dual-tapered shape. Such other particles may include other elongated fiber-containing particles prepared together with the dual-tapered particles from agglomerates of the present disclosure, but lacking development of the dual-tapered shape. The bulk product may consist of, or consist essentially of, fiber-containing particles from agglomerates prepared together during the tumbling processing. The bulk product may alternatively include other particles not prepared during the tumbling processing, for example particles blended with the fiber-containing particles after preparation of the fiber-containing particles from agglomerates formed during the tumbling. Such blended particles may or may not also include fibers, and when such blended particles include fibers, whose fibers may or may not be of the same type (e.g., carbon fibers) as the fibers of the fiber-containing particles prepared from the agglomerates from the tumbling processing. For example, the fiber-containing particles prepared from the agglomerates may be blended with conventional chopped tow pellets or other fiber-containing-pellets. In some preferred implementations, the bulk product of this second aspect includes a majority by weight (greater than 50 weight percent) of the fiber-containing particles with the dual-tapered shape, or an even larger percentage of the fiber-containing particles with the dual-tapered shape. When reference is made to a bulk product comprising a plurality of the fiber-containing particles with the dual-tapered shape, properties described for those fiber-containing particles apply to the fiber-containing particles with the dual-tapered shape in the bulk product, and not necessarily to other particles in the bulk product not having the dual-tapered shape. As noted above, the bulk products with the fiber-containing particles having a dual-tapered shape exhibit an advantageous combination of promoting enhanced flowability for handling prior to compounding, and exhibit enhanced dispersibility of the reinforcing fibers from the particles into polymer melt during extrusion processing to compound the fibers with polymeric matrix.

As noted above, methods of the present disclosure of making fiber-containing particles including recycled reinforcing fibers, and preferably with a large proportion the dual-tapered shape, include tumbling of a mixture of reinforcing fibers (e.g., recycled carbon fibers) and binder material to form agglomerates comprising reinforcing fibers and binder material. Such agglomerates may be recovered as, or may be further processed to prepare in a final form, fiber-containing particles for a bulk product. Such methods may comprise processing a fiber feed and a binder material to prepare fiber-containing particles including fibers from the fiber feed, wherein the fiber feed comprises reinforcing fibers in a non-continuous form and the processing comprises:
tumbling, and preferably rotational tumbling, of a mixture of the reinforcing fibers and the binder material to form agglomerates each comprising a portion of the reinforcing fibers and a portion of the binder material.

As will be appreciated, the fiber-containing particles made by such methods will not have the extremely high level of uniformity in size, shape and fiber orientation of conventional chopped tow pellets that are prepared from processing bundles of continuous virgin fibers. Remarkably, the tumbling processing may be advantageously used to prepare batches of fiber-containing agglomerates, many or even most of which develop the desired dual-tapered shape and with a significant degree of longitudinal alignment of fibers with the longitudinal direction of the agglomerates. During the rotational tumbling, a highly random fiber orientation in feed of recycled fibers and with fibers of varying length is transformed to a much more aligned configuration of the fibers, and the more aligned fibers are incorporated into agglomerates having the dual-tapered shape. Such agglomerates may be recovered for use as fiber-containing particles and in the bulk products, or may be further processed to prepare final fiber-containing particles, and preferably while largely retaining the dual-tapered configuration of dual-tapered agglomerates with significant alignment of fibers. Such further processing may include, for example, drying to remove residual process liquid, typically water, to improve particle integrity and to remove the liquid that might detrimentally volatilize during high polymer melt temperatures encountered during polymer extrusion during compounding. Such further processing may include other processing, as described below.

Even though the tumbling processing can be employed to prepare high-quality fiber-containing particles with advantageous properties for bulk products used as feed to compounding polymer with recycled reinforcing fibers, such as by extrusion, still because of the non-uniformity in length of recycled reinforcing fibers and high degree of randomness in longitudinal orientation of recycled reinforcing fibers, the yields of fiber-containing particles suitable for including in such bulk products has been relatively low, on the order of only about 60 percent. Off-specification agglomerates that are not suitable for preparing particles for such bulk products tend to contain some oversize fibers having a length dimension outside of a desired range, and such oversize fibers present a problem with respect to preparing bulk products suitable for feed to polymer compounding. One problem with the presence of the oversize fibers is that they lead to formation of some oversize agglomerates during tumbling, and which oversize agglomerates are too long for use in feed to polymer compounding with typical equipment. Another problem with the presence of the oversize fibers is that they are more likely to project out of the particle structure of the agglomerates in a way that detrimentally reduces bulk density and flowability of a resulting bulk product, which can lead to clogging and bridging of feed to polymer compounding. As a consequence, production of high-quality bulk products suitable for use as feed to polymer compounding has required classification and removal of oversize agglomerates following the tumbling processing, resulting in a loss of yield of bulk product suitable for polymer compounding from recycled reinforcing fiber feed. However, even then the presence of “fuzzy” agglomerates with strands of oversize fibers projecting out of the particle structure are detrimental to bulk density and flowability of the resulting bulk powders. Many of those “fuzzy” agglomerates can be removed by visual sorting, but such processing adds to cost and also results in a loss of yield. Moreover, because the removed agglomerates are held in a particle structure by binder material and liquid (typically water) from the initial process mixture subjected to tumbling, alternative uses for the off-specification agglomerates is limited, and it would be impractical and cost prohibitive to attempt to separate the reinforcing fibers in useful from the binder material and liquid. The liquid may be removed by drying, but then the particle structure of the dried agglomerate becomes hardened, which would further complicate attempting to separate the reinforcing fibers from the binder material. These problems are exacerbated by the high degree of variability in different recycled reinforcing fiber feedstocks, because process modifications to address problems with one feedstock type will not necessarily provide versatility to beneficially and efficiently also process other feedstocks of recycled reinforcing fibers, which can vary significantly in properties as discussed above.

Various enhancements in the processing of recycled reinforcing fibers disclosed herein are addressed to these problems, including through reduction in the quantity of problematic oversize reinforcing fibers in feed to tumbling agglomerate production and/or through reprocessing of off-specification agglomerates (e.g., oversize and “fuzzy” agglomerates), and which provide enhanced versatility in processing a variety of different recycled reinforcing feedstocks having different feedstock properties. Three significant processing enhancements are disclosed, which can beneficially each be used independently, but preferably are used in synergistic combinations to more effectively reduce problems associated with variability in feedstocks of recycled reinforcing fibers and potential for complications from introduction of oversize reinforcing fibers into the tumbling operation and increase yield and quality of bulk product suitable for use as feed to polymer compounding. With these enhancements, yield of agglomerates suitable for preparation of bulk products for use as feed to polymer compounding can be significantly increased, in some instances to 90 percent or more, and with more versatile application to a variety of different recycled reinforcing fiber feedstocks.

A first aspect of this disclosure is directed to a method of making a bulk product comprising fiber-containing particles with reinforcing fibers held in a particle structure by binder, and wherein the method comprises:
preliminary processing of reinforcing fibers, preferably recycled reinforcing fibers (e.g., recycled carbon fibers), to prepare a non-continuous fiber feed of non-continuous reinforcing fibers;
preparing agglomerates including at least a portion of the non-continuous reinforcing fibers of the non-continuous fiber feed and binder material, comprising combining the non-continuous fiber feed and the binder material in a process mixture and tumbling the process mixture; and
wherein the preliminary processing comprises:
   size classifying a mixture of non-continuous reinforcing fibers to prepare a plurality of fiber fractions including at least a first fiber fraction having a first weight average fiber length and a second fiber fraction having a second weight average fiber length, wherein the second weight average fiber length is larger than the first weight average fiber length; and
   preparing the non-continuous fiber feed to include at least a portion of non-continuous reinforcing fibers of the first fiber fraction.
      One advantage of such size classification of reinforcing fibers is significant reduction in the number of oversize fibers that ultimately are introduced into the process mixture for tumbling, and before the reinforcing fibers are mixed with binder and liquid to form a process mixture for tumbling. This promotes production of agglomerates of more uniform size. Longer reinforcing fibers of the second fiber fraction can advantageously be redirected to alternative processing without the added complication of being in a mixture with binder and liquid. Such alternative processing could, for example, be directed to preparation of alternative products or, more preferably, could include fiber length reduction (e.g., cutting the fibers) within the second fiber fraction and then continued processing of length-reduced fibers by tumbling to prepare agglomerates.

A second aspect of this disclosure is directed to a method of making a bulk product comprising fiber-containing particles with reinforcing fibers held in a particle structure by binder, wherein the method comprises:
preliminary processing of reinforcing fibers, preferably recycled reinforcing fibers (e.g., recycled carbon fibers), to prepare a non-continuous fiber feed of non-continuous reinforcing fibers;
preparing agglomerates including at least a portion of the non-continuous reinforcing fibers of the non-continuous fiber feed and binder material, comprising combining the non-continuous fiber feed and the binder material in a process mixture and tumbling the process mixture; and
wherein the preliminary processing comprises:
   increasing longitudinal alignment between the reinforcing fibers to prepare an aligned fiber feed; and
   preparing the non-continuous fiber feed to include at least a portion of the reinforcing fibers of the aligned fiber feed.
      One advantage of such fiber alignment is to improve the uniformity of recycled reinforcing fiber feed, leading to more uniform processing to prepare agglomerates, and applicable across varying feedstocks of recycled reinforcing fibers. For example, the fibers in such an aligned fiber feed can be subjected to length reduction (e.g., cutting of the fibers) to prepare cut fibers with much less variability in fiber length prior to mixing the fibers with binder and liquid to prepare a process mixture for tumbling. More uniform fiber lengths in the process mixture to tumbling contribute to production of agglomerates of more uniform size, even for a variety of different reinforcing fiber feedstocks.

A third aspect of this disclosure is directed to a method of making a bulk product comprising fiber-containing particles with reinforcing fibers held in a particle structure by a binder, wherein the method comprises:
production processing, comprising:
   (i) preparing agglomerates, comprising tumbling a process mixture comprising non-continuous reinforcing fibers, preferably recycled reinforcing fibers (e.g., recycled carbon fibers), and a binder material to form agglomerates including at least a portion of the non-continuous reinforcing fibers and at least a portion of the binder material, and wherein the agglomerates have a particle structure comprising:
      a particle length dimension, being a maximum separation distance in a longitudinal direction between first and second longitudinal ends of the agglomerate;
      a maximum particle width dimension transverse to the longitudinal direction at a longitudinal location between the first and second longitudinal ends; and
      an aspect ratio equal to the particle length dimension divided by the maximum particle width dimension; and
   (ii) subjecting the agglomerates to size classification to prepare a plurality of agglomerate fractions, the plurality of agglomerate fractions including at least a first agglomerate fraction having a first weight average particle length dimension and a second agglomerate fraction having a second weight average particle length dimension, wherein the first weight average particle length dimension is smaller than the second weight average particle length dimension; and
   (iii) processing at least a portion of the agglomerates of the first agglomerate fraction to provide fiber-containing particles with the particle structure for inclusion in a bulk product; and
for at least one said second agglomerate fraction prepared by the production processing, reprocessing the non-continuous fibers and the binder material of at least a portion of the second agglomerate fraction, the reprocessing comprising:
   (a) subjecting at least a portion, and preferably all, of the agglomerates of the second agglomerate fraction to length reduction processing to reduce the length of at least a portion of the non-continuous reinforcing fibers of the second agglomerate fraction to prepare reprocessed non-continuous reinforcing fibers, and optionally the length reduction processing comprises subjecting at least a portion of the second agglomerate fraction to one or more cutting operations; and
   (b) subjecting to a reprocessing occurrence of the production processing at least a portion of the reprocessed non-continuous reinforcing fibers from the second agglomerate fraction and at least a portion of the binder material from the second agglomerate fraction in the process mixture of the reprocessing occurrence of the production processing.
      It has been found that reinforcing fibers in oversize agglomerates can successfully be reprocessed to prepare smaller-size agglomerates, and therefore more uniform bulk products and with higher yield, even with the added complication of the fibers being in a mixture with binder and liquid in the oversize agglomerates. In a particularly advantageous example, the oversize agglomerates of the second agglomerate fraction can be subjected directly to fiber length reduction processing without separating the fibers from binder or liquid and can then be re-subjected to tumbling to prepare smaller-sized agglomerates, leading to higher quality bulk products with more uniform particle size and with higher yield of bulk product from initial feed of recycled reinforcing fibers.

A fourth aspect of this disclosure is directed to methods for making fiber-reinforced composites, which methods comprise dispersing reinforcing fibers from fiber-containing particles, for example from fiber-containing particles in bulk products made by methods of the first, second or third aspects, into a matrix. Such a fiber-reinforced composite may be fiber-reinforced polymer, in which the matrix is of polymeric material. When the matrix is a polymeric material, a method of the fourth aspect may include compounding the reinforcing fibers from the fiber-containing particles with polymer for the matrix, for example by extrusion during which the fibers are dispersed in polymer melt in an extruder. Extrudate, including the reinforcing fibers dispersed in polymeric matrix, may be pelletized, and the pellets may be used to prepare molded product forms in a molding operation, for example by injection molding. Such pellets may be used directly as feed to molding, preferably injection molding, or may be used as a masterbatch that is further compounded with and diluted into compatible polymer to prepare a final fiber-reinforced polymer composition with a desired level of fiber loading that is lower than the fiber loading in the masterbatch, and the final fiber-reinforced polymer composition is then used as feed to molding, preferably injection molding.

These and other aspects are further described in the following description, the appended claims and in the Figures. Moreover, a number of feature refinements and additional features are applicable to these aspects, which feature refinements and additional features may be used individually or in any combination within the subject matter of the first aspect or any other aspect of the disclosure. As such, each of the features described in the description below, including in the numbered exemplary implementation combinations and the appended claims, and/or illustrated in the drawings, may be but are not required to be, used with any other feature or combination of features of any of the aspects of this disclosure.

### BRIEF DESCRIPTION OF THE DRAWINGS

FIG. 1 illustrates features of an example fiber-containing particle of the present disclosure with a dual-tapered shape.

FIG. 2 illustrates features of another example fiber-containing particle of the present disclosure with a dual-tapered shape.

FIG. 3 is a generalized process diagram illustrating some example processing to make fiber-containing particles of the present disclosure.

FIG. 4 is a generalized illustration showing internal baffles in a rotatable process vessel, illustrated in the form of a rotating drum.

FIG. 5 is a generalized process diagram illustrating some example optional preliminary processing within the general processing of FIG. 3.

FIG. 6 is a generalized process diagram illustrating some example optional subsequent processing within the general processing of FIG. 3.

FIG. 7 is a generalized process diagram illustrating some example processing including preparation of a bulk product of the present disclosure.

FIG. 8 is a generalized process diagram illustrating some example optional composite preparation processing within the general processing of FIG. 7.

FIG. 9 is a generalized process diagram illustrating some example optional recycle processing to provide a preliminary feed of fibers within the general processing of FIG. 7.

FIG. 10 is a photographic image of an example feed of recycled carbon fibers, in which recycled carbon fibers have a high degree of randomness in orientation in a cotton ball-like structure.

FIG. 11 is a photographic image of two different example prepared batches of fiber-containing particles made with recycled carbon fibers, with the different batches prepared from recycled carbon fibers cut to different lengths and resulting in fiber-containing particles of different sizes.

FIG. 12 is a photographic image of a bulk product with an example batch of fiber-containing particles in a beaker.

FIG. 13 is a photographic image looking down on the bulk product of FIG. 12.

FIG. 14 is a photographic image a fiber-containing particle showing a well-developed dual-tapered shape and with fiber alignment in the longitudinal direction of the particle.

FIG. 15 is a photographic image showing the inside of a rotating drum with agglomerates made from recycled carbon fibers.

FIG. 16 is a partial perspective view of a vibratory conveyor deck with alignment channels.

FIG. 17 is a partial perspective view of a vibratory conveyor deck assembly with alignment slots.

FIG. 18 is an illustration of an example of increasing alignment of a population of reinforcing fibers relative to a machine direction of fiber conveyance.

FIG. 19 is an illustration of longitudinal orientation of an example reinforcing fiber and alignment angle relative to a machine direction of fiber conveyance.

FIG. 20 is a generalized process diagram illustrating an example of processing during agglomerate reprocessing.

FIG. 21 is a generalized process diagram illustrating an example of production processing during agglomerate reprocessing.

FIG. 22 is a generalized flow diagram illustrating an example of processing to make fiber-containing particles, and including recycle of off-specification agglomerates for reprocessing.

FIG. 23 is a generalize flow diagram illustrating an example of preparation of bulk product with fiber-containing particles with four stages of agglomerate reprocessing.

Features shown in the drawings are illustrated to assist with description and understanding of features applicable of various aspects of this disclosure, and features illustrated in the drawings are not necessarily to scale or detailed in every respect.

### DETAILED DESCRIPTION

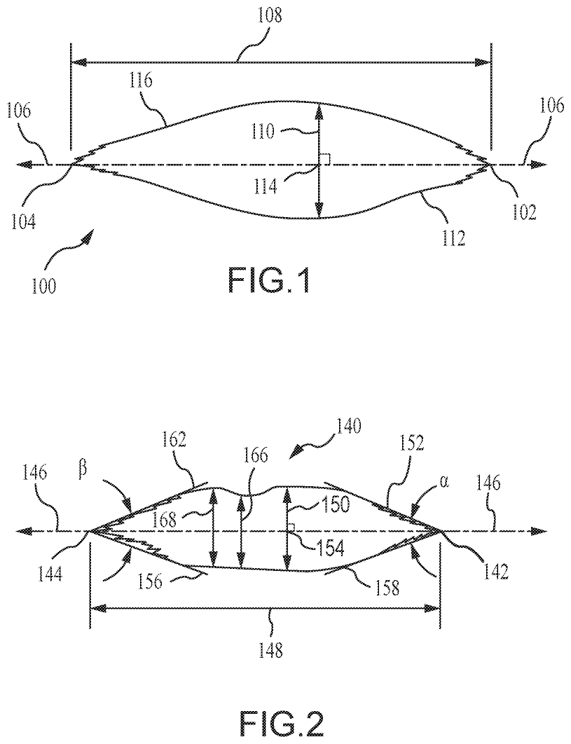

FIG. 1 illustrates features of some fiber-containing particles of the present disclosure having a dual-tapered shape. As shown in FIG. 1, a fiber-containing particle 100 has an elongated form with a first longitudinal end 102 and a second longitudinal end 104 and a longitudinal direction 106 between the first longitudinal end 102 and the second longitudinal end 104. The longitudinal direction 106 generally coincides with a longitudinal axis of the particle 100. However, it should be appreciated that the fiber-containing particles, such as particle 100, will generally not be symmetrical with respect to such a longitudinal axis, because although the fiber-containing particles of the present disclosure have elongated features, such particles are not perfectly symmetrical about a central axis as a consequence of the method of manufacture. The particle 100 has a particle length dimension 108, which is the linear distance between the first longitudinal end 102 and the second longitudinal end 104. As may be appreciated, the particle length dimension 108 represents a maximum separation distance in the longitudinal direction 106 between the first longitudinal end 102 and the second longitudinal end 104. The particle 100 also has a maximum particle width dimension 110 transverse (perpendicular) to the longitudinal direction 106. The maximum width dimension 110 represents a maximum separation distance between opposing surfaces of the particle 100 on a line transverse to the longitudinal direction 106. The particle 100 has an aspect ratio equal to the particle length dimension 108 divided by the maximum particle width dimension 110. The example particle 100 illustrated in FIG. 1 also has a dual-tapered shape with a first tapered portion 112 tapering in the longitudinal direction 106 away from a longitudinal location 114 of the maximum particle width dimension 110 toward the first longitudinal end 102 and with a second tapered portion 116 tapering in the longitudinal direction 106 away from the longitudinal location 114 toward the second longitudinal end 104.

FIG. 2 also illustrates features of such a fiber-containing particle with dual-tapered shape of the present disclosure. As shown in FIG. 2, a fiber-containing particle 140 includes a first longitudinal end 142, a second longitudinal end 144, a longitudinal direction 146, a particle length dimension 148, a maximum particle width dimension 150 at a longitudinal location 154, a first tapered portion 152 and a second tapered portion 156. FIG. 2 illustrates that the first tapered portion 152 tapers over a portion of a particle length dimension within a tapering envelope of a right circular cone 158 having an aperture (cone angle) a with an apex coinciding with the first longitudinal end 142. Similarly, the second tapered portion 156 tapers over a portion of the particle length dimension within a tapering envelope of a right circular cone 162 having an aperture (cone angle) B with an apex coinciding with the second longitudinal end 144. As may be appreciated, with the generally asymmetrical shapes of the fiber-containing particles resulting from a method of manufacture of the present disclosure, such an aperture α of a right circular cone envelope of a first tapered portion will typically be different than such an aperture β of a right circular cone envelope of a second tapered portion, even if often relatively similar in value. Also as illustrated in FIG. 2, it is not necessary for a fiber-containing particle of the present disclosure with dual-tapered shape to taper continuously from a location of the maximum particle width dimension towards each of the first longitudinal end and the second longitudinal end of the particle. In that regard, the example fiber-containing particle 140 illustrated in FIG. 2 includes a localized minimum width 166 and a localized maximum width 168 occurring in the longitudinal direction 146 between the maximum particle width dimension 150 and the second tapered portion 156. Also as may be appreciated, neither a first tapered portion nor a second tapered portion of such a dual-tapered particle of the present disclosure must taper completely and continuously to the respective longitudinal end of the fiber-containing particle. For example, the particle 140 may include a small portion near the first longitudinal end 142 that is not continuously tapering or is not within the tapering envelope of the right circular cone 158 and may include a small portion near the second longitudinal end 140 or that is not continuously tapering or is not within the tapering envelope of the right circular cone 162. As may be appreciated, a small bundle of fiber ends may occur in the vicinity of the first longitudinal end 142 and/or the second longitudinal end 144 that interrupt the taper of the first tapered portion 152 and/or the second tapered portion 156 near the respective longitudinal end 142, 144.

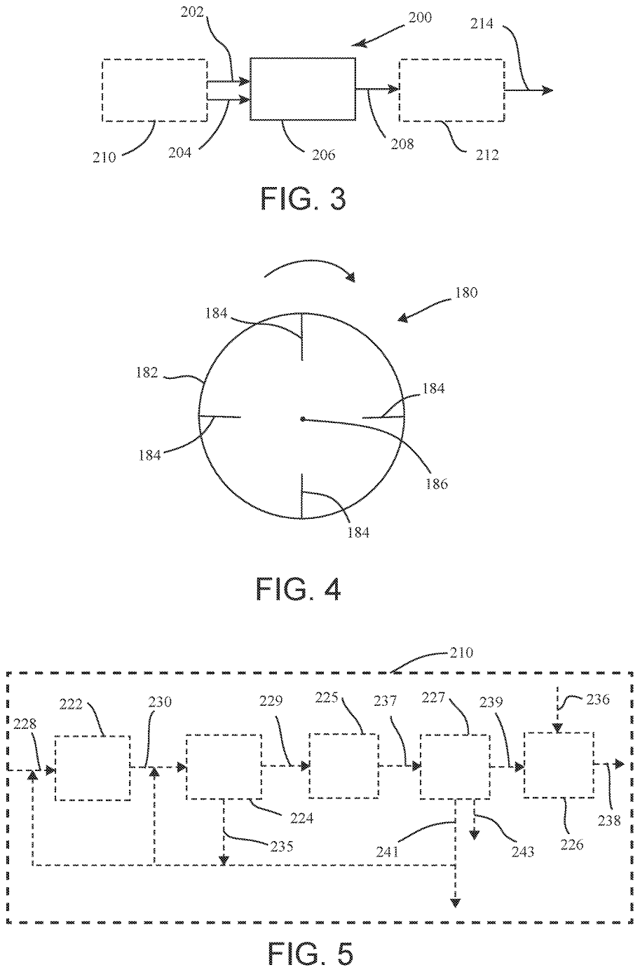

FIG. 3 shows a general process block diagram illustrating example processing 200 for making fiber-containing particles including reinforcing fibers held in a particle structure by a binder, and some or all of such particles may preferably include a dual-tapered shape, for example as illustrated in FIGS. 1 and 2. The processing 200 includes tumbling 206, which is preferably rotational tumbling, of a mixture of reinforcing fibers of a fiber feed 202 and binder material 204 to form agglomerates 208 containing reinforcing fibers in an alignment configuration in which the reinforcing fibers tend to be generally aligned to extend longitudinally in the longitudinal direction of the agglomerate. The rotational tumbling may typically be performed in a rotating vessel, such as a rotating drum or similar rotatable process vessel containing a mixture of reinforcing fibers of the fiber feed 202 and the binder material 204. Each of the fiber feed 202 and the binder material 204 may be introduced into the process vessel as a single addition or in multiple separate additions, and may be added alone or in a mixture or formulation with other materials. As an example, the binder material may be provided in a liquid suspension in which the binder material includes particulates suspended in a carrier liquid, typically an aqueous liquid. The fibers of the fiber feed 202 may be unsized fibers, for example carbon or other fibers which have not been coated with sizing. Alternatively, the fibers of the fiber feed 202 may be sized fibers, for example with base fiber structures of carbon or other fibers coated with a thin layer of sizing material. Sizing is typically a thin polymer coating that provides protection to an underlying base fiber structure (e.g., a carbon fiber structure) and/or acts as a compatibilizer to increase bonding with and/or dispersibility in an anticipated matrix material with which the fiber may be targeted for combination to prepare a fiber-reinforced composite. When the fibers are sized fibers prior to being mixed with binder material, the sizing is considered to be part of the fibers and part of the fiber content of the fiber-containing particles. When the fibers are sized fibers, the sizing typically makes up no more than 5 weight percent of the fibers, preferably not more than 3 weight percent of the fibers, and even more preferably not more than 2 weight percent of the fibers. A portion or all of the fiber feed 202 and binder material 204 may be introduced into the process vessel separately from each other or together in a mixture. The fiber feed 202 and/or the binder material 204 may be introduced into the process vessel prior to or during rotation of the process vessel. The rotating vessel may be operated in a batch mode to prepare batches of the agglomerates 208 from corresponding batches of fiber feed and binder material loaded into the vessel for the tumbling 206 as a batch, and at the end of the tumbling 206 of a batch, rotation of the vessel is halted and the agglomerates removed as a processed batch. Alternatively, the rotating vessel may be operated in a continuous or semi-continuous mode, for example with the fiber feed 202 and the binder material 204 introduced continuously or semi-continuously into an upstream portion of the rotating vessel and the agglomerates 208 removed from a downstream portion the rotating vessel.

Some important variables for operation of the tumbling 206 include the length of fibers being processed, the quantity of binder material used relative to the quantity of fibers being processed, and the relative amount of liquid (typically water) mixed with the binder material and fibers in the mixture subjected to tumbling. For rotational tumbling in a rotating vessel, some additional variables include the tangential speed (tip speed) of the inside wall of the rotating vessel during the tumbling and whether or not the rotating vessel includes internal baffles to promote more vigorous tumbling action, including at slower tangential speeds. In general, it has been found that resulting fiber-containing particles become larger as average fiber length becomes longer in the fiber feed. In many situations, a weight average length of the reinforcing fibers in the fiber feed may be in a range of from 1 millimeter to 18 millimeters. Resulting fiber-containing particles may often have a weight average particle length dimension that is about 2-3 times a weight average fiber length in fiber feed to the tumbling. When making fiber-containing particles particularly for compounding with polymer in an extruder, a preferred weight average particle length dimension for the fiber-containing particles is often smaller than about 14 millimeters for compatible processing with many conventional compounding systems. In general, it has also been found that as the proportion of binder material is increased, dispersibility of fibers from the fiber-containing particles during polymer compounding may be reduced, and at some point the amount of binder becomes too large to permit effective degradation of the fiber-containing particles during polymer compounding for effective dispersibility of the reinforcing fibers from the fiber-containing particles. As the amount of binder material is decreased relative to the quantity of fibers in fiber feed to the tumbling, particle integrity of the fiber-containing particles during handling may suffer, and at some point the amount of binder material becomes insufficient to maintain desirable particle integrity during handling operations prior to polymer compounding. In general, the binder material will typically be in an amount in a range of from about 0.5 weight percent to about 11 weight percent relative to the weight of the fibers, which provides about 0.5 weight percent to about 10 weight percent of binder in the final fiber-containing particles. It has also been generally found that if liquid (typically water) content in the process mixture during tumbling becomes either too large or too small, that the development of fiber-containing agglomerates with desired size, shape and particle integrity suffers. Insufficient water results in material not sufficiently bundling during the agglomeration process, that is, the fibers stay largely as discrete fibers. Excessive water results in bundles of larger length, width, and volume, at some point the bundles become so large in one or more such dimensions that the size of the bundles becomes incompatible for practical use with normal compounding and feeding equipment. Additional water beyond this point, will result in a slurry that will not adequately bundle into agglomerate particles. In general, liquid (typically water) content in the process mixture may often be in a range of from about 10 weight percent to about 50 weight percent relative to the total mixture weight (total weight of fibers plus binder material plus liquid plus any other minor components). The rotating vessel may be in the absence of internal baffles or may include internal baffles to promote more vigorous tumbling action, especially when operating at slower tangential speeds during rotational tumbling in a rotating vessel. In general, tangential speeds of the inside wall of the rotating vessel during rotational tumbling may often be a range of from 0.3 to 1.4 meters per second, and with tangential speeds in a range of from about 0.6 meters per second to about 0.8 meters per second working well in many tested operations in a rotating drum not including internal baffles. Rotational speeds too high will lead to fiber sticking against the drum wall without much or any tumbling mechanism for bundling. Rotation speeds too low will lead to a slow or negligible rate of bundle production. Adding internal baffles should permit operation of a rotating vessel at slower speeds to attain satisfactory results compared to the same rotating vessel without internal baffles. When internal baffling is used, the rotating vessel includes at least one, and preferably at least three, internal baffles inwardly projecting into the interior of the vessel from the rotating wall of the vessel. In some preferred implementations, internal baffles may be equally spaced radially about an axis of rotation of the vessel. Baffles may preferably extend from the wall into the vessel a distance of up to 50 percent of a radius of the vessel, and may preferably extend at least 50 millimeters from the vessel wall. Baffles may preferably be oriented to extend into the vessel at a right angle to a tangent to the vessel wall and to extend longitudinally in alignment with the axis of rotation. Alternatively, one or more baffles may be pitched at other than a right angle relative to a tangent to the wall and/or may be longitudinally oriented not in alignment with the axis of rotation (e.g., spiraling along the vessel wall). FIG. 4 illustrates a rotatable process vessel 180, shown in the form of a rotating cylindrical drum, including a vessel wall 182 and four baffles 184 equally spaced radially about an axis of rotation 186 and projecting inwardly from the vessel wall 182 toward the axis of rotation 186. For illustration purposes, FIG. 4 shows a directional arrow indicating rotation of the process vessel 180 in a clockwise direction about the axis of rotation 186, although rotation could alternatively be in a counter-clockwise direction.

Generally, bulk products with the fiber-containing particles tend to exhibit better flowability with increasing untapped bulk density of the bulk product, with increasing tapped bulk density of the bulk product and with decreasing angle of repose of the bulk product. For particular fiber feed having weight average fiber lengths in ranges for processing as disclosed herein, suitable processing conditions to prepare agglomerates for fiber-containing particles may be selected and optimized through normal processing trials with adjustments of the noted processing variables, and without undue experimentation, to obtain fiber-containing particles with suitable sizes and shapes, and exhibiting suitable properties for handling in a bulk product and for degradation and dispersion of fibers during polymer compounding.

As shown in FIG. 3, the illustrated method may include optional preliminary processing 210 to prepare the fiber feed 202 and/or the binder material 204 in a form desired for the tumbling 206, preferably rotational tumbling, and/or may include optional subsequent processing 212 to prepare a product of final fiber-containing particles 214 from the processing 200. As may be appreciated, in a case when the example method of FIG. 3 does not include subsequent processing 212, the agglomerates 208 may constitute the final fiber-containing particles 214 of the processing of FIG. 3. The fiber-containing particles 214 may be recovered as or incorporated into a bulk product.

In the example illustration of the preliminary processing 210 in FIG. 5, a preliminary fiber feed 228 is subjected to processing including five optional operations of first length reduction 222 (e.g., first cutting) of reinforcing fibers, followed by alignment 224 of reinforcing fibers, followed by second length reduction 225 (e.g., second cutting) of reinforcing fibers, followed by fiber size classification 227 of reinforcing fibers and then premixing 226 reinforcing fibers with binder material feed 236 to prepare a premixture 238 for processing in the tumbling 206 (FIG. 3). When the method of the present disclosure includes the processing of the first aspect of this disclosure, then the preliminary processing 210 includes the fiber size classification 227, and with the other operations of first length reduction 222, alignment 224, second length reduction 225 and premixing 226 being preferred but optional for inclusion in the preliminary processing 210. When the method of the present disclosure includes the processing of the second aspect of this disclosure, then the preliminary processing 210 includes the alignment 224, and with the other operations of first length reduction 222, second length reduction 225, fiber size classification 227 and premixing 236 being optional but preferred for inclusion in the preliminary processing 210. When the method of the present disclosure includes the third aspect of this disclosure, then the preliminary processing 210 includes the first length reduction 222 or the second length reduction 225, and preferably both of them, and the other illustrated processing operations in FIG. 5 are preferred but optional for inclusion in the preliminary processing 210.

In the optional first length reduction 222, reinforcing fibers from the preliminary fiber feed 228 are cut or otherwise subjected to fiber length reduction to prepare processed reinforcing fibers 230 having a shorter weight average fiber length than reinforcing fibers fed to the first length reduction 222.

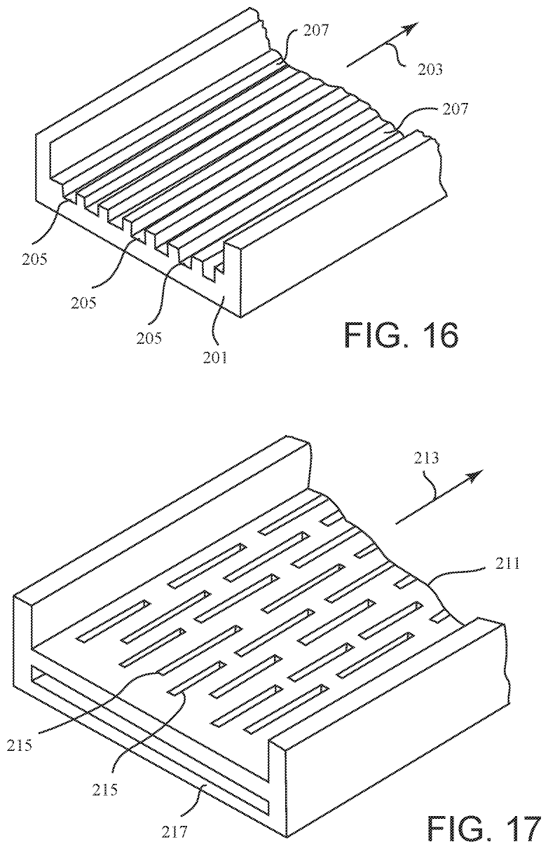

In the optional alignment 224, longitudinal alignment between the reinforcing fibers being processed is increased from a more random longitudinal orientation of reinforcing fibers in feed to the alignment 224 to a more longitudinally aligned orientation of reinforcing fibers as an aligned fiber feed of the processed reinforcing fibers 229. In addition to increasing longitudinal alignment between the fibers, during the alignment 224 the longitudinal alignment of the reinforcing fibers is preferably increased relative to a machine direction of travel, or conveyance, of the reinforcing fibers during the alignment 224, and including increased longitudinal alignment of the reinforcing fibers with the machine direction of conveyance of the reinforcing fibers to and during the second length reduction 225. The longitudinal alignment of fibers relative to each other and relative to the machine direction of conveyance may be accomplished using any available fiber alignment technique, with some examples of alignment processing being to contact the reinforcing fibers with alignment channels or alignment slots extending longitudinally in a machine direction of conveyance. As reinforcing fibers contact and settle into alignment channels and/or alignment slots the degree of longitudinal alignment of the reinforcing fibers is increased. Such alignment channels and/or alignment slots may the part of a vibratory conveyor, for example. Reference is now made to FIGS. 16 and 17 illustrating examples of increasing fiber alignment through the use of alignment channels and/or alignment slots provided on a vibratory conveyor.

FIG. 16 shows a portion of a conveyance deck 201 of a vibratory conveyor to convey reinforcing fibers being processed in a machine direction 203 of conveyance. The conveyance deck 201 includes a plurality of alignment channels 205 longitudinally extending in the machine direction 203. As reinforcing fibers are vibrated and move along the conveyance deck 201 in the machine direction 203 reinforcing fibers will contact and tend to be biased into alignment with the longitudinally-extending channel walls 207 of the alignment channels 205. Reinforcing fibers settling into the alignment channels 205 during conveyance along the conveyance deck 201 will largely be aligned longitudinally with the machine direction 203. During operation, the conveyance deck 201 is vibrated, and vibrations may be imparted laterally and/or vertically, with both lateral and vertical vibrations being preferred. The conveyance deck 201 may be inclined downwardly in the machine direction 203 to assist conveyance of the reinforcing fibers in the machine direction 203. After alignment in the alignment channels, the aligned reinforcing fibers may continue to be conveyed for downstream processing, for example in the second length reduction 225. Such further conveyance may be along a distal portion of the conveyance deck 201 not including the alignment channels 205 or may be by transfer of the aligned reinforcing fibers to a subsequent conveyance unit. Some reinforcing fibers might not align with and settle into the alignment channels 205, and such non-settling reinforcing fibers may be separated from the reinforcing fibers that have settled into the alignment channels 205 or may continue to be conveyed for further processing. Even when not all of the reinforcing fibers being processed settle into the channels, overall alignment of the reinforcing fibers being processed is significantly improved.

FIG. 17 shows a portion of a conveyance deck 211 of a vibratory conveyor to convey reinforcing fibers being processed in a machine direction 213 of conveyance. The conveyance deck 211 includes a plurality of alignment slots 215 extending longitudinally in the machine direction 213. As reinforcing fibers are vibrated and move along the conveyance deck 211 in the machine direction 213, the reinforcing fibers will contact the alignment slots 215 and tend to be biased into alignment with the slots, and reinforcing fibers becoming sufficiently aligned with the alignment slots 215 will settle into and pass through the alignment slots 215 to be collected on and transported along a lower deck 217 of the vibratory conveyor. The reinforcing fibers passing through the alignment slots 215 will have a significantly increased alignment with each other and with the machine direction 213. The aligned fibers on the lower deck 217 may continue to be conveyed downstream for further processing, for example for processing in the second length reduction 225. During operation, the conveyance deck 211 and lower deck 217 are vibrated, together or independently, with lateral and/or vertical vibrations, and preferably both, and the conveyance deck 211 and the lower deck 217 may be inclined downwardly in the machine direction 213 to assist conveyance of the reinforcing fibers in the machine direction 213. The aligned reinforcing fibers on the lower deck 217 may be conveyed along the lower deck to subsequent processing or may be transferred to another conveyance unit for further conveyance. Some reinforcing fibers being processed might not pass through the alignment slots, and such reinforcing fibers may be removed and subjected to alternative processing, or may be recombined with the more-aligned reinforcing fibers on the lower deck 217. Even when not all of the reinforcing fibers being processed have been aligned through the slots and are recombined with reinforcing fibers passing through the slots, overall alignment of the reinforcing fibers being processed is significantly improved.

Alignment channel and alignment slot features of FIGS. 16 and 17 can also be combined to promote development of an even higher degree of alignment of reinforcing fibers. For example, the alignment channels 205 of FIG. 16 could have narrower alignment slots extending longitudinally on the bottom of the alignment channels 205, through which reinforcing fibers could pass to further increase fiber alignment. Similarly, the lower deck 217 of FIG. 17 could be configured with alignment channels extending longitudinally in the machine direction of conveyance 213

For advantageous processing it is beneficial for the alignment channels 205 or slots 215 to have a length dimension in the machine direction of fiber conveyance that is longer than most of the reinforcing fibers being processed and a width dimension transverse to the length dimension that is much smaller, and preferably with the width dimension being smaller than the length of most of the reinforcing fibers being processed through the alignment 224. As shown in FIG. 5, optionally some reinforcing fibers 235 that do not successfully align during the alignment 224 can be removed and recycled for reprocessing through the first length reduction 222 or through the alignment 224 without prior length reduction. Many of those fibers may tend to be very long and may benefit from another pass through the first length reduction 224 prior to another pass through the alignment 224.

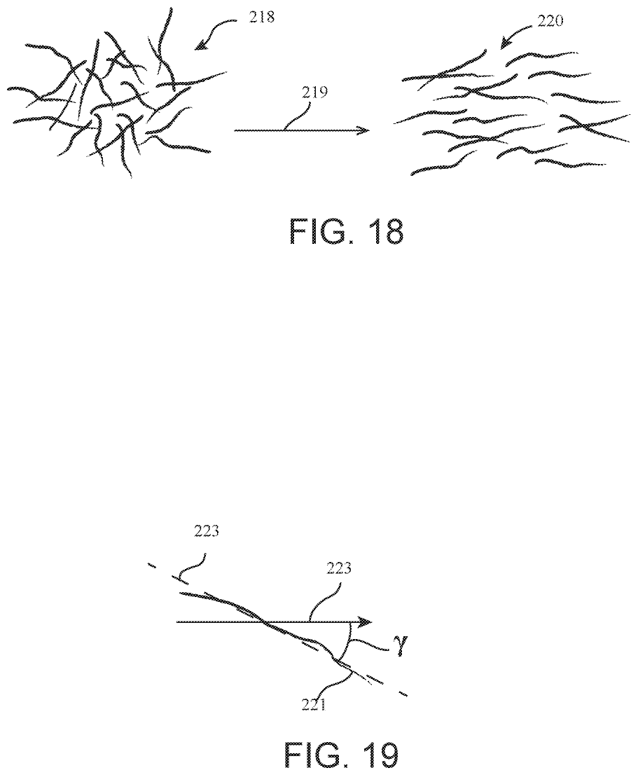

Referring now to FIG. 18, an example is shown of reinforcing fibers as they may be longitudinally oriented in a more random fashion in feed to the alignment 224 and in a more aligned configuration following processing in the alignment 224. FIG. 18 shows a feed of reinforcing fibers 218 to the alignment 224 of FIG. 5 and being conveyed in a machine direction 219 for processing in the alignment 224. The highly random orientation of reinforcing fibers in the feed of reinforcing fibers 218 is characteristic of recycled reinforcing fibers recovered from fiber-reinforced composites. The randomness of fiber orientation in such recycled materials makes such recycled materials particularly challenging for processing into particle structures suitable for use as feed to polymer compounding. FIG. 18 also shows an aligned fiber feed 220, such as might be present in the processed reinforcing fibers 229. As illustrated in FIG. 18, the longitudinal orientation of the reinforcing fibers in the feet of reinforcing fibers 218 is highly random, both between the reinforcing fibers and relative to the machine direction 219. In contrast, the aligned fiber feed 220 includes reinforcing fibers that are significantly more aligned longitudinally with each other and with the machine direction 219.

One measure of the degree of alignment of a reinforcing fiber with a machine direction of conveyance is the alignment angle of the reinforcing fiber with the machine direction. The alignment angle is an acute or right angle (0° to 90°) between a longitudinal orientation of the fiber and the reference direction such as the machine direction. FIG. 19 illustrates an example reinforcing fiber 221 that has a longitudinal alignment with a machine direction 223 of conveyance at an alignment angle γ between the longitudinal direction of the fiber 221 and the machine direction 223. Such an alignment angle can vary from 0° (essentially parallel alignment with a reference direction) to 90° (essentially perpendicular alignment with a reference direction). As will be appreciated, reinforcing fibers may be somewhat flexible and may not extend longitudinally in a perfectly straight line, as illustrated in FIG. 19. However, the alignment angle can be represented relative to a line 231 of a linear fit of the points along longitudinal axis of the reinforcing fiber 221. Such a linear fit can represent for example a linear regression fit of points along the reinforcing fiber 221. A quantification of alignment of a degree of alignment of reinforcing fibers in a population, or group, of reinforcing fibers with a machine direction of conveyance can be determined using high resolution visualization techniques, such as for example a machine vision system, to provide data on the reinforcing fibers in the population and determination of fiber orientations using appropriate data analysis techniques. Using such high resolution visualization techniques and appropriate data analysis, longitudinal orientation of individual reinforcing fibers can be analyzed and alignment angles determined relative to a reference direction, for example a machine direction. Alignment angles can be determined for all or a statistically representative portion of the population and representation of the degree of alignment for the fiber population can be calculated. For example, an average alignment angle for a population of reinforcing fibers can be calculated by averaging the determined alignment angles. Such averaging may be on any convenient and useful basis, such as for example an average alignment angle can be determined on a number average basis, a weight average basis, a length average basis or a volume average basis. Alternatively, or supplementary to determination of an average alignment angle, useful indications of degree of the narrowness or breadth of distribution of fiber alignment with a reference direction, such as a machine direction of conveyance, can be obtained by analyzing fractions of the population that are either in close alignment with or significantly out of alignment with the reference direction. With the example processing as illustrated in FIG. 5, a high degree of alignment of the reinforcing fibers in the aligned fiber feed of the processed reinforcing fibers 229 will result in a more controlled and uniform cut of reinforcing fibers during subsequent processing in the second length reduction 225, contributing to a more uniform fiber length in the fiber feed 202 to the tumbling 206 (FIG. 3), reducing the occurrences of oversize fibers and consequently the occurrences of off-specification agglomerates 208 (FIG. 3). For example, one indication of the degree of longitudinal alignment of reinforcing fibers with a machine direction of conveyance can be represented as a population of reinforcing fibers having an average alignment angle (e.g., number average, weight average, volume average or length average) not exceeding a maximum desired average value for processing. As another example, an indication of the degree of longitudinal alignment of reinforcing fibers with a machine direction of conveyance can be represented as narrowness of distribution of the alignment angles in a population of reinforcing fibers, for example as a maximum permitted fractional portion (e.g., number percent, weight percent, volume percent, length percent etc.) that is outside of a maximum desired alignment angle or that is significantly larger than an average alignment angle value for the population.

As will be understood, a weight average property (e.g., weight average length dimension, width dimension, aspect ratio or alignment angle) of a population, or batch, of particles (e.g., agglomerates or reinforcing fibers) refers to an average for the property determined with a weighting for particle weight, and can be expressed as:

$${Q}_{WA} = {\sum }_{i = 1}^{n} ( Qi \times Wi ) / {\sum }_{i = 1}^{n} Wi$$

where Q_{WA} is the weight average property, Qi and Wi are the value of the property and the particle weight, respectively, of each individual particle of the population, or batch, and n is the number of particles in the population, or batch. Similarly, a weight percentage refers to a percentage on a weight basis of the total cumulative weight of all of the particles in the population, or batch of particles. As will further be appreciated, weight average properties can also be equivalently expressed as mass average properties.

As will be understood, a volume average property (e.g., volume average length dimension, width dimension, aspect ratio or alignment angle) of a population, or batch, of particles (e.g., agglomerates or reinforcing fibers) refers to an average for the property determined with a weighting for particle volume (including particle internal porosity), and can be expressed as:

$${Q}_{VA} = {\sum }_{i = 1}^{n} ( Qi \times Vi ) / {\sum }_{i = 1}^{n} Vi$$

where Q_{VA} is the volume average property, Qi and Vi are the value of the property and the particle volume, respectively, of each individual particle of the population, or batch, and n is the number of particles in the population, or batch. Similarly, a volume percentage refers to a percentage on a volume basis of the total cumulative volume of all of the particles in the population, or batch of particles.

As will be understood, a length average property (e.g., length average alignment angle) of a population, or batch, of particles (e.g., reinforcing fibers) refers to an average for the property determined with a weighting for particle length dimension, and can be expressed as:

$${Q}_{LA} = {\sum }_{i = 1}^{n} ( Qi \times Li ) / {\sum }_{i = 1}^{n} Li$$

where Q_{LA} is the length average property, Qi and Li are the value of the property and the particle length, respectively, of each individual particle of the population, or batch, and n is the number of particles in the population, or batch. Similarly a length percentage refers to a percentage on a length basis of the total cumulative lengths of all of the particles in the population, or batch of particles.

As will be understood, a number average property (e.g., number average length dimension, width dimension, aspect ratio or alignment angle) of a population, or batch, of particles (e.g., agglomerates or reinforcing fibers) refers to a simple mathematical average of the property for particles of the population, or batch, determined without weighting, and can be expressed as:

$${Q}_{NA} = ( {\sum }_{i = 1}^{n} Qi ) / n$$

where Q_{NA} is the Number average property, Qi is the value of the property of each individual particle of the population, or batch, and n is the number of particles in the population, or batch. Similarly a number percentage refers to a percentage on a number basis of the total number of particles in the population, or batch of particles.

As will be appreciated, if a population of reinforcing fibers in the second length reduction 225 is being cut, or chopped, by a blade disposed transverse to a machine direction of conveyance of the fibers and operated to provide a set cut length in the machine direction, reinforcing fibers that have an alignment angle at or close to 90° have a possibility of not being cut at all or if cut will tend to be cut into lengths significantly longer than a desired fiber length for processing into agglomerates. This leads to a wider distribution of cut fiber lengths in the cut fiber product, and such a wider distribution of cut fiber lengths significantly complicates further processing to prepare fiber-containing particles with desirable properties for use as feed to polymer compounding. Minimizing in particular the fraction of reinforcing fibers having an alignment angle over 45° has been found to significantly improve uniformity of cuts and subsequent processing of the cut fibers to prepare suitable agglomerates directed to polymer compounding applications.

With reference again primarily to FIG. 5, even when the preliminary processing 210 does not include the alignment 224, reinforcing fiber processing will still tend to benefit from having two length reduction operations (222 and 225), but inclusion of the alignment 224 is preferred to provide more uniformity in cut fibers in processed reinforcing fibers 237 from the second length reduction 225. As with the first length reduction 222, the second length reduction 225 can be any length reduction technique or combination of techniques for reducing the average fiber length of reinforcing fibers being processed, but in preferred implementations each includes cutting the reinforcing fibers with a cutting blade preferably with the blade oriented transverse to the machine direction of conveyance of the reinforcing fibers through the respective length reduction operation.

It has been found that for reinforcing fiber feed having a high degree of randomness in fiber alignment, such as is typically the case for recycled reinforcing fibers, performing the first length reduction 222 (e.g., a first cut) of the reinforcing fibers prior to the alignment 224 provides a better and more repeatable degree of resulting fiber alignment, as the reinforcing fibers in the feed to the alignment 224 will tend to be in a more uniform range of lengths and as such will be better suited for processing through the alignment 224.

As shown in FIG. 5, the processed reinforcing fibers 237 from the second length reduction 225 may be subjected to further optional processing in the fiber size classification 227. During the fiber size classification 227, the mixture of non-continuous reinforcing fibers in the processed reinforcing fibers 237 are separated into multiple different fiber fractions having different weight average fiber lengths. Such fiber size classification can be accomplished, for example, by any technique or combination of techniques to separate the reinforcing fibers based on fiber size, which will typically be based on fiber length, as in a typical situation the reinforcing fibers being processed will tend to be of the same general composition (e.g., carbon fibers) and will tend to have relatively uniform fiber diameters, and the size of the fibers will vary primarily in length. Some example separation techniques for use in the fiber size classification 227 include air classification, vibratory sorting, screening or combination thereof.

In the example illustrated in FIG. 5, the processed reinforcing fibers 237 fed to the fiber size classification 227 are processed to prepare a first fiber fraction 239 that is subjected to further processing to prepare the fiber feed 202 (FIG. 3) and a second fiber fraction 241. The second fiber fraction 241 represents primarily oversize fibers, and the second fiber fraction 241 accordingly has a weight average fiber length that is larger than the weight average fiber length of the first fiber fraction 239 that is further processed to prepare the fiber feed 202. As shown in FIG. 5, some or all of the second fiber fraction 241 may be recycled to upstream within the preliminary processing. Such recycle may beneficially be to a location just upstream of the second length reduction 225, alignment 224 or first length reduction 222, for an additional passive processing through one or more of those prior operations. Alternatively, some or all of the second fiber fraction 241 may be removed from the preliminary processing 210 to be subjected to alternative processing to prepare a different product. In preferred processing, the second fiber fraction 241 will be recycled to feed to upstream of the alignment 224, and more preferably to upstream of the first length reduction 222.

As also illustrated in FIG. 5, during the fiber size classification 227, the feed of the processed reinforcing fibers 237 can be separated into more than two fiber fractions each having a different weight average fiber length. In the illustration of FIG. 5, optional preparation is shown of a third fiber fraction 243, which in this example has a smaller weight average fiber length than the first fiber fraction 239. In the illustration of FIG. 5, the reinforcing fibers included in the third fiber fraction 243 tend to be smaller than desired for inclusion in the fiber feed 202 and in the agglomerates 208 (FIG. 3). Reinforcing fibers in the third fiber fraction 243 may be diverted to alternative processing, for example to a milling operation to prepare a milled product, which can be used for example as polymer filler.

In the optional premixing 226, a feed of fibers (e.g., the first fiber fraction 239) to the premixing 226 is mixed with a binder material feed 236, which includes some or all of the binder material 204 for the tumbling 206, to prepare a premixture 238 including fibers and the binder material. During the premixing 226 the reinforcing fibers are mixed with a liquid (typically water) and such a liquid may be introduced as a liquid component of the binder material feed 236 and/or may be introduced separately from the binder material feed 236. As will be appreciated, the feed of reinforcing fibers to the premixing 226 may be the processed fibers 230 when the preliminary processing 210 includes the first length reduction 222 but not the other illustrated intermediate operations, may be the processed fibers 229 when the preliminary processing 210 includes the alignment 224 but not the other intermediate operations, may be the processed fibers 237 when the preliminary processing 210 includes the second length reduction but not the fiber size classification 227, or may be the first fiber fraction 239 when the preliminary processing 210 includes the fiber size classification 227. In a particularly preferred embodiment, the preliminary processing 210 includes all of the first length reduction 222, the alignment 224, the second length reduction 225 and the fiber size classification 227 prior to the premixing 226. And in an even more preferred embodiment, the preliminary processing 210 also includes the premixing 226. Some or all of the fiber feed 202 and the binder material 204 may be provided to the tumbling 206 in the form of the premixture 238.

As should be appreciated, the reinforcing fibers will typically be in a dry form as processed through the first length reduction 222, the fiber size alignment 224, the second length reduction 225 and the fiber size classification 227, whereas the premixture 238 will typically include the reinforcing fibers in a mixture with liquid, typically an aqueous liquid carrier for the binder material 204 (FIG. 3).

It should be appreciated that although the sequence of processing illustrated in FIG. 5 is a preferred sequencing, the sequence of different ones of the process operations illustrated in FIG. 5 can be altered, at least to some degree. For example, the alignment 224 could be performed before the first length reduction 222. The fiber size classification 227 could also be performed before the first length reduction 222 or between the first length reduction 222 and the second length reduction 225. Moreover, as with all processing illustrated herein, the processing illustrated in FIG. 5 can include additional process operations, either inserted into the illustrated sequence or before or after the illustrated sequence. For example, the processing illustrated in FIG. 5 could include multiple fiber size alignment operations, for example before each of the first length reduction 222 and the second length reduction 225. As another example, the processing illustrated in FIG. 5 could include multiple fiber size classification operations, for example between the first length reduction 222 and the second length reduction 225 and after the second length reduction 225.

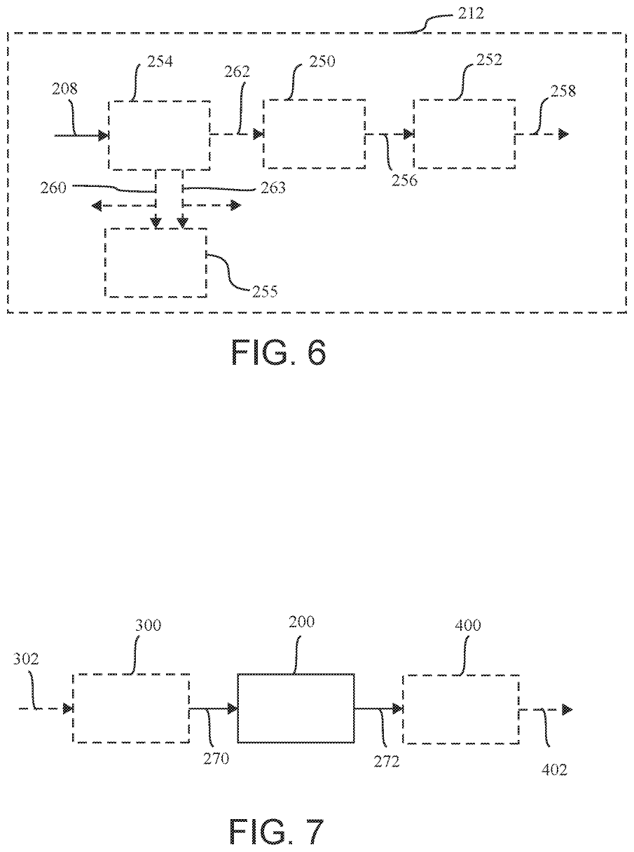

FIG. 6 shows a general process diagram of an example of some processing that may be performed during the optional subsequent processing 212 of FIG. 3. The optional subsequent processing 212 as illustrated in FIG. 6 may include one, or any combination of two or more, of the optional processing operations of particle size classification 254, drying 250, curing 252 and reprocessing 255. In one preferred implementation, when the binder material is of a type not requiring curing, the subsequent processing 212 includes the particle size classification 254, drying 250 and reprocessing 255. In another preferred implementation, when the binder material is of a type requiring curing, subsequent processing 212 includes the particle size classification 254, the drying 250, the curing 252 and the reprocessing 255. When the method of the present disclosure includes the third aspect of this disclosure, then the subsequent processing 212 as illustrated in FIG. 6 includes the particle size classification 254 and the reprocessing 255.

It should be appreciated that although the sequence of processing illustrated in FIG. 6 is a preferred sequencing, the sequence of different ones of the process operations illustrated in FIG. 6 can be altered, at least to some degree. For example, the particle size classification 254 could alternatively be performed after the drying 250 or after the curing 252, in which case the reprocessing 255 would be performed on the agglomerates following such drying 250 and/or curing 252. However, it is preferred that the particle size classification 254 be performed prior to drying or curing operations, because the agglomerates of the second agglomerate fraction 260 and/or the third agglomerate fraction 263 will be easier to process during the reprocessing 255 and liquid (e.g., water) and binder material contained in the agglomerates 208 can be beneficially employed during the reprocessing 255.

In the particle classification 254, the feed of fiber-containing particles, in the form of the agglomerates 208 (FIG. 3), is subjected to the particle size classification 254 to separate the feed of particles into multiple fractions having different weight-average particle sizes. In the example illustrated in FIG. 6, the agglomerates 208 are processed in the particle size classification 254 to prepare a first agglomerate fraction 262 and a second agglomerate fraction 260, and with the first agglomerate fraction 262 having a smaller weight average particle length dimension than the weight average particle length dimension of the second agglomerate fraction 260. The particle size classification 254 may include size separating the agglomerates 208 into more than two different particle fractions. The illustrated processing of FIG. 6 includes optional preparation also of a third agglomerate fraction 263, which in the illustrated example is an intermediate fraction having a weight average particle length dimension that is larger than that of the first agglomerate fraction 262 and smaller than that of the second agglomerate fraction. The particle size classification 254 may include size-separation of the agglomerates by one or more size separation techniques, for example one or more of screening, vibratory classification, air classification, centrifugal classification, optical sorting and electrostatic classification. A preferred method for size separation within the particle size classification includes screening. As will be appreciated, when preparing three agglomerate fractions as illustrated in the optional alternatives of FIG. 6, processing could include two screens, one screen having a larger opening size and another screen having a smaller opening size, wherein the first agglomerate fraction 262 could include agglomerates passing through the smaller-sized screen and the second agglomerate fraction 260 could include agglomerates retained on the larger-sized screen, and the third agglomerate fraction could include agglomerates passing the larger-sized screen and being retained on the smaller-sized screen. The first agglomerate fraction 262 will tend to have a narrower distribution of particle length dimension, and optionally one or more other dimension properties, relative to agglomerates fed to the particle size classification 254. In the processing of FIG. 6 the agglomerates of the first agglomerate fraction 262 are optionally further processed through the drying 250 and/or the curing 252 to prepare the bulk product 214 (FIG. 3).

As will be appreciated, because the agglomerates 208 tend to have an elongated particle shape, sizing of screens for size classification is not as simple as for granular particles. A particular screen size may pass a significant number of particles having a length dimension larger than the screen opening size, and accordingly a screen size for a particular separation will tend to be somewhat smaller than the length dimension of a target particle length to pass through the screen for collection. However, if the screen size is too small, then a significant number of the desired particles might be excluded from passing through the screen. In general, the screen size should be at least large enough to accommodate the expected particle width dimensions of the agglomerates desired to pass through the screen, and in practice the screen opening size will be some degree larger than anticipated particle width dimensions and smaller than a targeted particle length dimension desired to pass through the screen for collection. As one example, it has been found that a screen size of about 0.25 inch (6.35 millimeters) seems to work well for passing agglomerates with a particle length dimension of about 11-13 millimeters and not passing a lot of agglomerates having a length dimension significantly longer than that. Also, the quality of the separation can be increased by subjecting the undersize fraction through a second screening with the same screen opening, to further reduce the number of overly-long particles in the collected undersize fraction. Also, it has been found that the quality of the collected undersize fraction is improved if agglomerates as recovered from the tumbling (e.g., agglomerates 208 of FIGS. 3 and 6) are subjected to a first screening with a larger screen opening size to first remove very large agglomerates, following by a second screen with an opening size to pass the desired agglomerates for collection. It has been found that when targeting collection of agglomerates with a particle length dimension of about 11-13 millimeters, that a first screen with an opening size of about 0.375 inch (9.53 millimeters) and a second screen with an opening size of about 0.25 inch (6.35 millimeters) works well in many situations. Screen separation may also be aided by shaking and/or vibrating the screens. As will be appreciated, appropriate screen sizes can be determined for any particular agglomerates through simple testing on representative samples of agglomerate batches.

During the optional drying 250, the agglomerates in the first agglomerate fraction 262 are dried to reduce the content of residual liquid, typically water, to a desired low level for the fiber-containing particles 214. During the drying 250 the agglomerates are preferably subjected to elevated temperature and/or reduced pressure to facilitate evaporation of liquid from the agglomerates to prepare processed agglomerates 256 with reduced liquid content relative to agglomerates in the first agglomerate fraction 262.

For situations in which the fiber-containing particles 214 will be extruded with polymer, components that may vaporize at high temperatures encountered during the extrusion are often problematic, and this includes any residual water content that could vaporize during the extrusion processing. Accordingly, in some preferred implementations, the water content in the dried agglomerates 256, and in the fiber-containing particles 214, is very low, typically not more than 0.5 weight percent water, and preferably not more than 0.3 weight percent water and even more preferably not more than 0.2 weight percent water. However, there may be some minor level of residual water, for example at least 0.001 weight percent water or even at least 0.01 weight percent water.

The optional curing 252 may be included when the binder material requires curing to fully set and form a final binder composition in cured particles 258. Curing may be activated by any appropriate energy source depending on the nature of the binder material 204, for example radiation (light) or heat, with thermal curing being generally more preferred for most curing implementations. The curing 252 may be included, for example, when the binder material 204 comprises thermoset resin (e.g., epoxy resin) that crosslinks during curing. In some implementations the binder material will include thermoplastic polymer, and not thermoset resin. Binder systems using thermoplastic polymers may often be processed without a need for the curing 252. However, some binder systems using thermoplastic polymers may benefit from the processing including the very high temperature treatment of the curing 252, for example to remove chemical functional groups from the thermoplastic polymer that may have been added to the polymer to improve solubility in aqueous solutions or to improve wetting of fibers by the thermoplastic polymer. When the subsequent processing 212 of FIG. 6 includes the drying 250, then a feed to the curing 252 may be the dried agglomerates 256 and otherwise may be the agglomerates of the first agglomerate fraction 262 or may be the agglomerates 208 when the processing does not include either the particle size classifying 254 or the drying 250. When the subsequent processing 212 includes both the drying 250 and the curing 252, the drying 250 and the curing 252 may be performed as separate operations or may be performed as separate stages in a combined operation, for example with the drying 250 being first performed at a lower elevated temperature and then the curing 252 being performed in the same process equipment (e.g., the same oven) at a higher elevated temperature following the drying 250.

As shown in FIG. 6, some or all of the second agglomerate fraction 260 and/or the third agglomerate fraction 263 is subjected to the reprocessing 255. Also as shown in FIG. 6, some or all of the second agglomerate fraction 260 and/or the third agglomerate fraction 263 can be diverted to alternative processing than the reprocessing 255, although when the subsequent processing 212 includes the reprocessing 255 at least a portion of at least one of the second agglomerate fraction 260, and optionally the third agglomerate fraction 263, is fed to the reprocessing 255. Typically at least some, and preferably substantially all, of the second agglomerate fraction 260 is subjected to the reprocessing 255.

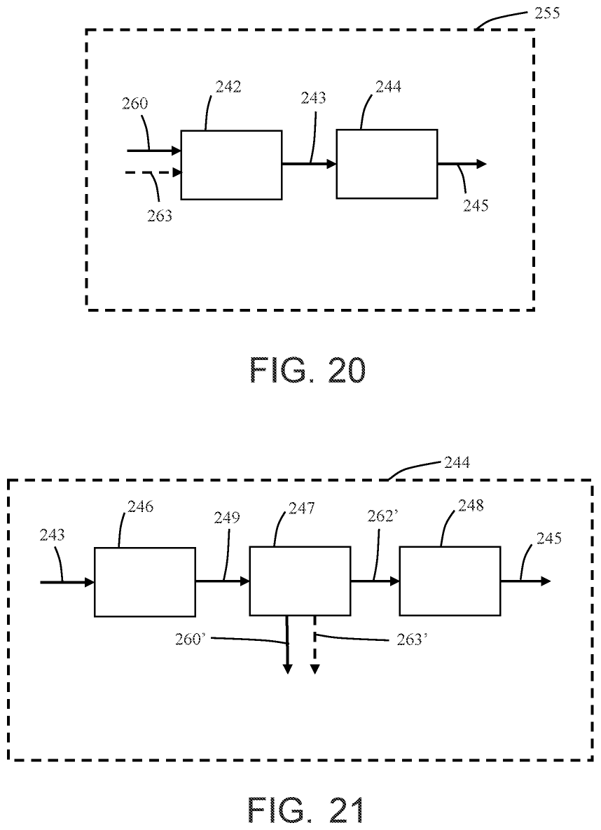

FIG. 20 shows an example of processing that may be performed during the reprocessing 255 with feed of at least a portion of the second agglomerate fraction 260, and optionally of the third agglomerate fraction 263. In the example reprocessing 255 of FIG. 20, agglomerates are subjected to length reduction processing 242 (e.g., by cutting) to reduce the length of at least a portion of the non-continuous reinforcing fibers in the second agglomerate fraction 260 to prepare reprocessed reinforcing fibers 243 having a smaller weight average length dimension of reinforcing fibers than in the second agglomerate fraction 260. In addition to reducing the length reinforcing fibers, the length reduction processing 243 also beneficially disassociates the reinforcing fibers from a particle structure of the agglomerates fed to the length reduction processing. As should be appreciated, the reprocessed reinforcing fibers 243 will be in a mixture with binder material and liquid that were present in the agglomerates fed to the length reduction processing 242. The reprocessed reinforcing fibers 243, along with associated binder material and liquid, are then provided to production processing 244 to prepare fiber-containing particles 245 for inclusion in a bulk product.

During the length reduction processing 242, the reinforcing fibers of the second agglomerate fraction 260, and optionally of the third agglomerate fraction 263, are subjected to appropriate fiber length reduction techniques, for example cutting with the blade. The length reduction processing 242 may, for example, include fiber-length reduction techniques and processing that are the same as or similar to those as discussed with respect to the first length reduction 222 and/or the second length reduction 225 of FIG. 5. One possibility is to introduce the reprocessed reinforcing fibers 243 into the preliminary processing 210 of FIG. 5, for example either upstream of the first length reduction 222 or between the first length reduction 222 and the second length reduction 225, in which case the length reduction processing 242 of FIG. 20 may be provided by the first length reduction 222 and/or the second length reduction 225 of the preliminary processing 210 of FIG. 5. Preferably, however the length reduction processing 242 is performed separately from the preliminary processing 210, because the presence of the liquid and binder material associated with the reprocessed reinforcing fibers 243 significantly complicate what is otherwise dry fiber processing during the first length reduction 222 and the second length reduction 225 of FIG. 5.

When the length reduction processing 242 of FIG. 20 is performed separately from the preliminary processing 210 of FIG. 5 then the agglomerates of the second agglomerate fraction 260 and/or the third agglomerate fraction 263 may advantageously be processed “as is” including the liquid and binder material. In preferred processing, the agglomerates of the second agglomerate fraction 260, and optionally the third agglomerate fraction 263, include a liquid (e.g., water) concentration and a binder material concentration that is the same or similar to such concentrations in the agglomerates 208 recovered from the tumbling 206, from which the first agglomerate fraction 260, and optionally the third agglomerate fraction 263, were prepared, and the reprocessed reinforcing fibers 243 will be in a mixture with liquid and binder material from the first agglomerate fraction 260, and optionally from the third agglomerate fraction 263. Preferably the mixture with the reprocessed reinforcing fibers 243 will also include the liquid and the binder material in the same or similar concentrations as in the agglomerates of the second agglomerate fraction 260, and optionally the third agglomerate fraction 263, as fed to the length reduction processing 242. Liquid may be added as needed, for example to compensate for liquid that may have been lost to evaporation during processing between initial recovery of the agglomerates 208 from the tumbling 206 and recovery of the reprocessed reinforcing fibers 243 from the length reduction processing 242 or as otherwise desired for the tumbling performed during the production processing 244. Between initial recovery of the agglomerates 208 from the tumbling 206 and recovery of the reprocessed reinforcing fibers 243 from the length reduction processing 242.

In the production processing 244 of FIG. 20, the reprocessed reinforcing fibers 243 are subjected to particular processing operations to prepare the fiber-containing particles 245. Reference is now made to FIG. 21 illustrating example of processing during the production processing 244 of FIG. 20. The example production processing 244 of FIG. 21 includes preparing agglomerates 246, followed by particle size classification 247, followed by preparing fiber-containing particles 248, resulting in production of the fiber-containing particles 245.

With continued reference to FIG. 21, during the preparing agglomerates 246, a process mixture including the reprocessed reinforcing fibers 243 and binder material, and typically also liquid (e.g., water) is subjected to tumbling to form reprocessed agglomerates 249 including at least a portion of the reprocessed reinforcing fibers 243 and associated binder material and liquid of the process mixture. Such reprocessed agglomerates 249 may have a particle structure the same or similar to those discussed elsewhere herein, for example as illustrated or discussed in relation to FIGS. 1-3, and the tumbling can be performed in a similar or the same manner as described for operation of the tumbling 206 (FIG. 3). As noted, the process mixture for the tumbling during the preparing agglomerates 246 will also typically include liquid (e.g., water) and the process mixture may have components and properties as discussed for the tumbling 206 (FIG. 3) or as discussed elsewhere herein. For example, the process mixture for tumbling during the preparing agglomerates 246 can include concentrations of reinforcing fibers, binder material and water as described elsewhere herein. In a preferred implementation of the preparing agglomerates 246, the process mixture subjected to the tumbling includes binder material and liquid (e.g., water) of the second agglomerate fraction 260 and/or the third agglomerate fraction 263 recovered from the particle size classifying 254, and preferably in the same or similar concentration as in the agglomerates 208. Advantageously, binder material and liquid from an initial tumbling processing (e.g., tumbling 206 of FIG. 3) and still associated with the reprocessed reinforcing fibers 243 following the preparing agglomerates 246 can be beneficially reprocessed along with the reprocessed reinforcing fibers 243 to prepare the reprocessed agglomerates 249 during the production processing 244.

As shown in FIG. 21, the reprocessed agglomerates 249 are subjected to the particle size classification 247 to prepare multiple fractions of the reprocessed agglomerates 249, including least a first agglomerate fraction 262′ and a second agglomerate fraction 260′, and with the second agglomerate fraction 260′ having a larger weight average particle length than the first agglomerate fraction 262′. More than two agglomerate fractions may be prepared during the particle size classification 247, and FIG. 21 shows optional preparation of a third agglomerate fraction 263′, which may have a weight average particle length intermediate between that of the first agglomerate fraction 262′ and the second agglomerate fraction 260′. The first agglomerate fraction 262′, the second agglomerate fraction 260′ and the third agglomerate fraction 263′ may, for example, have particle structures and properties the same or similar to as described for the first agglomerate fraction 262, second agglomerate fraction 260 and third agglomerate fraction 263, respectfully, from the particle size classification 254 in the processing of FIG. 6, or as described elsewhere herein. The particle size classification 247 may be conducted in the same or similar manner and using the same or similar equipment as the particle size classification 254 of FIG. 6.

As shown in FIG. 21, the second agglomerate fraction 262′ is then subjected to the process operation of preparing fiber-containing particles 248 to produce the fiber-containing particles 245. When the agglomerates in the second agglomerate fraction 262′ have particle structure and properties as desired for inclusion in a bulk product, the preparing fiber-containing particles 248 may simply include collecting some or all of the agglomerates of the second agglomerate fraction 262′ as a batch of the fiber-containing particles 245 for inclusion in a bulk product. Alternatively, the agglomerates of the second agglomerate fraction 262′ may be processed during the preparing fiber-containing particles 248 to modify one or more properties of the agglomerates of the second agglomerate fraction 262′ to prepare the fiber-containing particles 245 in a modified form. Such processing during the preparing fiber-containing particles 248 may include, for example, a drying operation and/or a curing operation, for example similar to or the same as for the drying 250 and the curing 252 of FIG. 6. In some alternative implementations, some or all of the production processing 244 of FIG. 21 may be performed by introducing the reprocessed reinforcing fibers, along with associated binder material and liquid, into a suitable point in the processing of FIG. 3. For example into the premixing 226 of FIG. 5 so that the premixture 236 includes recycled reinforcing fibers of the reprocessed reinforcing fibers 243 and the binder material and liquid associated with the reprocessed reinforcing fibers.

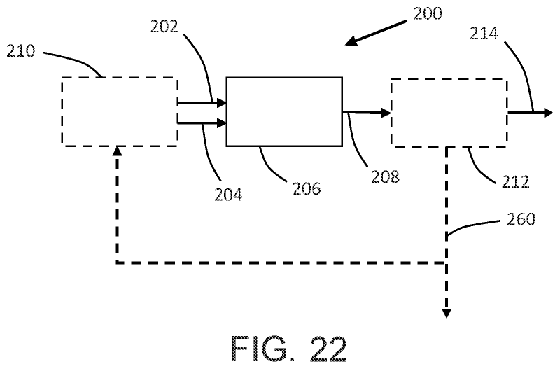

In some implementations, the length reduction processing 242 and the production processing 244 of the reprocessing 255 may be performed by way of recycling agglomerates of the second agglomerate fraction 260, and optionally the third agglomerate fraction 263, to within the preliminary processing 210 of FIG. 3, with appropriate modifications to account for the presence of binder material in liquid in the recycled agglomerates. An example of such an implementation is illustrated in FIG. 22, where the agglomerates of the second agglomerate fraction 260 from the subsequent processing 212 (for example as resulting from the particle size classification 254 of FIG. 5) are recycled to the preliminary processing 210. For example, the second agglomerate fraction 260 (and/or the third agglomerate fraction 263 if present) from the particle size classification 254 of FIG. 6 could be recycled to just upstream of the first length reduction 222 or just upstream of the second length reduction 225 of the preliminary processing 210 of FIG. 5. In that case, the length reduction processing 242 of FIG. 20 can be provided by the first length reduction 222 and/or the second length reduction 225 of FIG. 5 and the preparing agglomerates 246 of the production processing 244 of FIGS. 20 and 21 can be provided by reprocessing through the tumbling 206 of FIG. 3, the particle size classification 247 of the production processing of FIGS. 20 and 21 can be provided by the particle size and the particle size classification 254 of FIG. 6 and the preparing fiber-containing particles 248 of the production processing of FIGS. 20 and 21can be provided by the drying 250 and/or curing 252 of the of FIG. 6. However, similar to the discussion above, the presence of liquid and binder material in the second agglomerate fraction 260 complicates recycle processing of the second agglomerate fraction 260 with fresh feed of dry reinforcing fibers through the first length reduction 222 and/or the second length reduction 225, and accordingly it is especially preferred to not recycle the second agglomerate fraction 260 (or the third agglomerate fraction 263) to the preliminary processing 210 of FIG. 3.

In more preferred implementations, agglomerates of the second agglomerate fraction 260, and optionally the third agglomerate fraction 263, are processed separately from the processing of FIGS. 3, 5 and 6, even though such separate processing can include processing similar to operations performed in the processing of FIGS. 3, 5 and 6 (e.g., reinforcing fiber length reduction, tumbling, agglomerate particle size classification and drying).

Additionally, a quantity of reinforcing fibers can be subjected to multiple instances of reprocessing in oversize agglomerates separated out by particle size classification following preparation of the agglomerates, and bulk products can be prepared with similar properties following each instance of reprocessing. However, it has also been found that bulk product properties can degrade if reinforcing fibers are subjected to too many occurrences of reprocessing including fiber length reduction. Generally, subjecting reinforcing fibers in oversize agglomerates to fiber length reduction processing during more than three successive occurrences of reprocessing will tend degrade the properties of the resulting bulk product. The fiber-containing particles prepared through initial processing and through each instance of reprocessing oversized agglomerates can be blended into a combined bulk product, or can be maintained as separate bulk product batches, for improved quality control and product tracking.

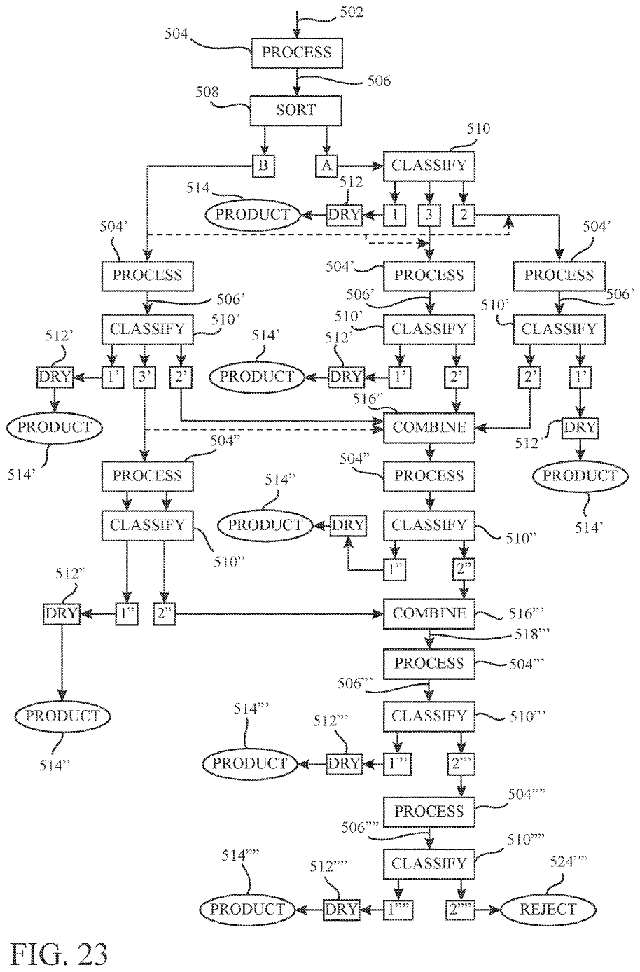

Reference is now made to FIG. 23 illustrating one example of processing including separate reprocessing of oversize agglomerate fractions and with reinforcing fibers being subjected to reprocessing up to a maximum of four times. In the processing of FIG. 23, a number not followed by an apostrophe indicates a feature associated with initial processing of an initial feed of recycled reinforcing fibers (e.g., by the processing of FIGS. 3, 5 and 6), a number followed by a single apostrophe (′) indicates a feature associated with a first stage of reprocessing reinforcing fibers, a number followed by two apostrophes (″) indicates a feature associated with a second stage of reprocessing reinforcing fibers, a number followed by three apostrophes (″′) indicates a feature associated with a third stage of reprocessing reinforcing fibers and a number followed by four apostrophes (″″) indicates a feature associated with a fourth stage of reprocessing reinforcing fibers.

In the processing of FIG. 23, a feed 502 of reinforcing fibers is subjected to processing 504 to prepare agglomerates 506. The feed 502 of reinforcing fibers can be comprised of recycled reinforcing fibers (e.g., carbon fibers) previously recovered from fiber-reinforced composite, and typically the feed of reinforcing fibers 502 will comprise non-continuous reinforcing fibers in a dry form. The processing 504 includes at least length reduction processing to reduce the weight average length of reinforcing fibers of the feed 502 and tumbling a process mixture with length-reduced reinforcing fibers and the binder material to form the agglomerates 506. The tumbling of the processing 504 may be as described for the tumbling 206 of the processing of FIG. 3, and preferably will involve rotary tumbling, for example in a rotating vessel. The agglomerates 506 resulting from the processing 504 of FIG. 23 can be or have features described in relation to the agglomerates 208 prepared by the processing of FIG. 3. Processing prior to tumbling in the processing 504 may include one or more operations described in relation to the preliminary processing 210 of FIG. 3 or FIG. 5. For example, length reduction of reinforcing fibers during the processing 504 may include one or both of the first length reduction 222 or second length reduction 225 of the preliminary processing 210 of FIG. 5. Also, processing prior to tumbling during the processing 504 may include one or more, and preferably will include at least the alignment 224, more preferably will include at least the alignment and the premixing 226, and more preferably will include all of the alignment 224, fiber size classification 227 and premixing 226.

Following preparation, the agglomerates 506 are subjected to sorting 508 to remove non-conforming agglomerates 506. The sorting 508 may, for example, involve a visual conformance inspection and removal of agglomerates 506 that are visually identifiable as deficient in size or structure (e.g., “fuzzy” agglomerates). An accepted fraction of agglomerates (A) from the sorting 508 continues with initial processing and a rejected fraction of agglomerates (B) is redirected for reprocessing.

The accepted fraction of agglomerates (A) is subjected to particle size classification 510 to separate the agglomerates into three fractions, with agglomerate fraction 1 having the smallest weight average particle length, agglomerate fraction 2 having the largest weight average particle length and agglomerate fraction 3 having an intermediate weight average particle length between that of fraction 1 and fraction 2. This same convention on naming classified agglomerate fractions is maintained throughout FIG. 23, with a fraction identified as 1 having a weight average particle length smaller than that of a fraction identified as 2 and with a fraction identified as 3 having a weight average particle length intermediate between a fraction 1 and a fraction 2. The particle size classification 510, and other particle size classification steps during reprocessing stages of FIG. 23, may include any technique or combination of techniques for separating particles into size-separated fractions, for example in a one or more the techniques described elsewhere herein. The particle size classification 510, or other particle size classification steps during reprocessing stages of FIG. 23, may be or have features as described for the particle size classification 254 of subsequent processing 212 of FIG. 6.

The agglomerate fraction 1 from the classification 510 is subjected to drying 512 and the dried agglomerates are collected for a bulk product 514. Agglomerate fractions 2 and 3 from the classification 510 and the reject agglomerate fraction B from the sorting 508 are each separately reprocessed through a first stage of reprocessing including processing 504′ and classification 510′.

During the processing 504′ of a first reprocessing stage, the off-specification agglomerates being processed are subjected to length reduction processing to reduce the weight average length of the reinforcing fibers in the agglomerates. The length reduction processing may, for example, include processing that is the same as or similar to the first length reduction 222 and/or the second length reduction 225 in the preliminary processing 210 of FIG. 5. After the length reduction processing, the processing 504′ includes tumbling a process mixture comprising reinforcing fibers and binder material to prepare first-stage reprocessed agglomerates 506′. The tumbling during the processing 504′ may be the same or similar as to the tumbling performed during the processing 504, and may be as described for the tumbling 206 of the processing of FIG. 3, and preferably will involve rotary tumbling, for example in a rotating vessel.

As will be appreciated, the agglomerates fed to the processing 504′ will contain reinforcing fibers, liquid and binder material, and preferably the length reduction processing during the processing 504′ is performed on the agglomerates substantially as prepared with liquid and binder material during the initial processing 504, and without substantial drying of the agglomerates and without substantial alteration of the particle structure of the agglomerates prior to the length reduction processing. Also preferably, the agglomerates being subjected to the reprocessing are maintained in an environment to prevent substantial evaporation of liquid prior to the length reduction processing during the processing 504′, and the liquid and binder material are retained with the length-reduced reinforcing fibers for inclusion in the process mixture subjected to the tumbling during the processing 504′. However, if an appreciable amount of liquid has been lost to evaporation during processing prior to the tumbling during the processing 504′, then additional liquid may be added to account for that lost to evaporation to prepare the process mixture with a desired concentration of liquid for the tumbling.

The processing prior to tumbling during the processing 504′ may include, in addition to length reduction processing, other processing leading to preparation of the process mixture for the tumbling. For example, the processing 504′ may include an alignment step to better longitudinally aligned agglomerates with a machine direction of conveyance to a size reduction (e.g., cutting) operation to improve uniformity of the length reduction processing of the reinforcing fibers of the agglomerates being processed. Such an alignment of agglomerates may include any alignment techniques, for example in any of the alignment techniques described with respect to the alignment 224 of fibers in the processing of FIG. 5, adapted to processing the agglomerate particles rather than dry, non-continuous reinforcing fibers. As another example, the processing 504′ could include premixing components for the process mixture to be tumbled, for example by adding liquid if needed prior to the tumbling.

During the first stage of reprocessing, the first-stage reprocessed agglomerates 506′ are subjected to particle size classification 510′ to prepare either two size-separated agglomerate fractions (1′ and 2′) or to prepare three size-separated agglomerate fractions (1′,2′ and 3′). In each case, the agglomerate fraction with the smallest weight average particle length (1′) is subjected to drying 512′ and the dried agglomerates are collected for a bulk product 514′. Each of the agglomerate fractions (each 2′ fraction and 3′ fraction) having a larger weight average particle length is subjected to a second stage of reprocessing. Some or all of those larger particle length agglomerate fractions may be combined for a second stage of reprocessing, or may be separately subjected to second-stage reprocessing. In the example processing illustrated in FIG. 23, the 2′ agglomerate fractions are combined 516″ for a second stage of reprocessing and the 3′ agglomerate fraction is separately subjected to a second stage of reprocessing.

Processing during a second stage of reprocessing is similar to as described for a first stage of reprocessing. During a second stage of reprocessing, the off-specification agglomerates being processed are subjected to processing 504″ to prepare second-stage reprocessed agglomerates 506″, which are then subjected to classification 510″ to prepare separated agglomerate fractions (1″ and 2″). The smaller-size agglomerate fraction (1″) is subjected to drying 512″ and the dried agglomerates are collected for a bulk product 514″. The processing 504″ will include at least length reduction processing to reduce the weight average fiber length of reinforcing fibers in the agglomerates subjected to a second stage reprocessing and tumbling to prepare the second-stage reprocessed agglomerates 506″, and may include other operations, for example as discussed with respect to the processing 504′ during a first stage of reprocessing.

The off-specification agglomerates (fraction 2″) from a second stage of reprocessing is then directed to a third stage of reprocessing. In the example of FIG. 23, the off-specification agglomerates (fraction 2″) are combined 516′″ for a third stage of reprocessing. During a third stage of reprocessing, the combined off-specification agglomerates 518″″ are subjected to processing 504′″ to prepare third-stage reprocessed agglomerates 506′″, which are then subjected to particle size classification 510′″ to prepare two size-separated agglomerate fractions (1′″ and 2″″). The agglomerate fraction with the smaller weight average particle length (1″′) is subjected to drying 512″′ and the dried agglomerates are collected for a bulk product 514″+.

The off-specification agglomerate fraction (2″′) from the third stage of reprocessing is then directed to a fourth stage of reprocessing. During a fourth stage of reprocessing, the off-specification agglomerates are subjected to processing 504″″ to prepare fourth-stage reprocessed agglomerates 506″″, which are then subjected to particle size classification 510″″ to prepare size-separated agglomerate fractions (1″″ and 2″″). The agglomerate fraction with a smaller weight average particle length (1″′) is subjected to drying 512″″ and the dried agglomerates are collected for a bulk product 514″′. The off-specification agglomerate fraction (2″″) represents a final rejected fraction 524″′, which is either disposed of or directed to alternative processing, for example to a milling operation to prepare a milled product.

The processing 504″′ and 504″″ of the third and fourth stages of reprocessing can involve the same or different processing, provided that each includes length reduction processing to reduce the weight average length of reinforcing fibers of the respective agglomerates being processed and the tumbling of the length-reduced reinforcing fibers to prepare agglomerates. Preferably, the processing 504″′ and 504″″ of the third and fourth stages of reprocessing are the same or similar to the processing 504″ of second stage reprocessing. Likewise, the classification 510′″ and 510″″ of the third and fourth stages of reprocessing can involve the same or different size classification or size classification techniques, and are preferably the same or similar, and more preferably are the same or similar to the classification 510″ of a second stage of reprocessing.

Reference is now made to FIG. 7, which shows a generalized process diagram of an example of processing for making a fiber-containing product. The processing of FIG. 7 includes the processing 200 of FIG. 3 in which a preliminary feed of fibers 270 is processed to prepare a fiber-containing bulk product 272. The preliminary feed of fibers 270 may for example be provided in the form of the fiber feed 202 of FIG. 3 when the processing 200 does not include the preliminary processing 210, or the preliminary feed of fibers 270 may be in the form of the preliminary fiber feed 228 when the processing 200 includes the preliminary processing 210. The fiber-containing bulk product 272 may be in the form of a batch of the fiber-containing particles 214 of the processing 200 of FIG. 3. The bulk product 272 may be a blended product including the fiber-containing particles 214 mixed with one or more other particulate components, for example with other fiber-containing particles that may include additional fibers, which may be of the same composition or different composition than the fibers of the fiber-containing particles 214. For example, the bulk product 272 could include a blend of carbon fibers in the fiber-containing particles and additional carbon fibers or additional fibers of a different composition (not carbon fibers) contained in other particles. As shown in FIG. 7, the method optionally includes processing that may be performed before and/or after the processing 200. The processing of FIG. 7 may optionally include recycle processing 300 to process a composite material feed 302 to prepare the preliminary feed of fibers 270 and/or the processing of FIG. 7 may optionally include composite preparation processing 400 to prepare a fiber-reinforced composite product 402.

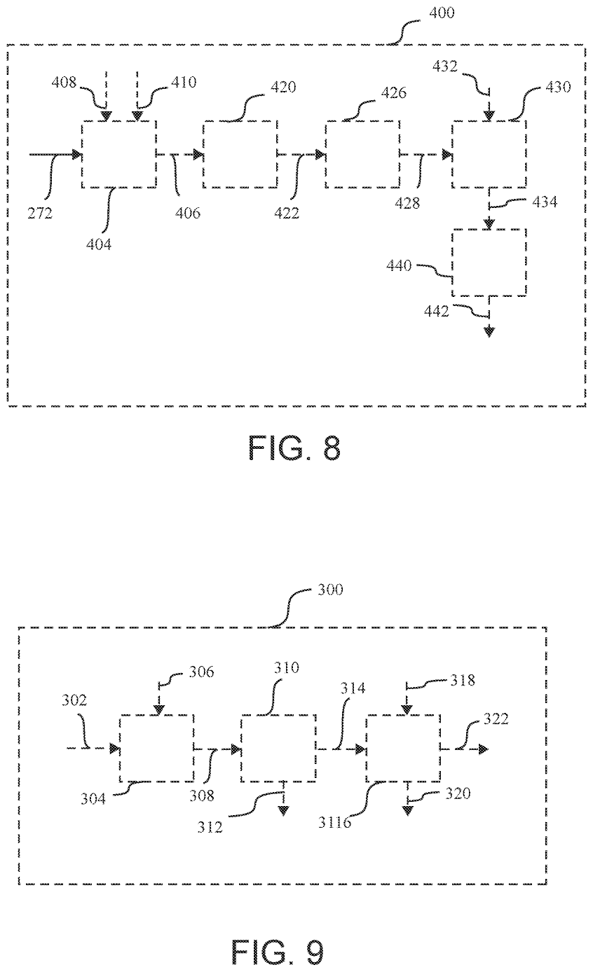

FIG. 8 shows a general process diagram of some example processing that may be performed during the optional composite preparation processing 400 to prepare a fiber-reinforced composite product including reinforcing fibers from the fiber-containing bulk product 270. In the example of FIG. 8, the composite preparation processing 400 may include dispersing 404 fibers of the fiber-containing bulk product 272 in a matrix to form a fiber-reinforced composite 406. Material for the matrix may be provided in a matrix material feed 408. Additional components 410 may also be fed to the dispersing 404 to be included in the composite 406. Such additional components 410 may include additives such as functional or non-functional filler and/or processing aids. The additional components 410 may include additional reinforcing fibers, in addition to the reinforcing fibers from the fiber-containing bulk product 272, and which additional reinforcing fibers may be of the same type or a different type than the fibers in the fiber-containing bulk product 272. In some preferred processing implementations, the dispersing 404 includes extruding polymeric material of the matrix material feed 408 and adding fiber-containing particles of the bulk product 272 into the polymeric material during the extruding, in which case the composite material 406 may be in the form of an extrudate.

With continued reference primarily to FIG. 8, the optional processing 400 may also include cooling 420, during which the composite 406 is cooled, for example by passing the composite 406 through a bath of cooling liquid (e.g., water). This processing may be desired when the composite as prepared during the dispersing 404 is at an elevated temperature, such as in the case of extrusion. A cooled composite 422 from the cooling 420 may be subjected to pelletizing 426 to prepare pellets 428 of fiber-reinforced composite material. The pelletizing 426 may include, for example, cutting an extruded strand of desired diameter into cylindrically-shaped pellets of a desired length. After the pelletizing 426, the pellets 428 may be subjected to blending 430 during which the pellets 428 may be mixed with one or more other particulate component 432 that is different than the pellets 428 to form a blended bulk product 434. The optional processing may also include molding 440, in which a fiber-reinforced composite feed is molded, preferably by injection molding, to prepare a molded product 442. The fiber-reinforced composite feed to the molding 400 may be, for example, the pellets 428 when the processing 400 does not include the blending 430, or may be the blended bulk product 434 when the processing 400 includes the blending 430. As may be appreciated, the pellets 428 or the blended bulk product 434 may be sold as a bulk product, and buyer may use the pellets 428 or bulk product 434 for performance of the molding 440 or for another purpose.

With continued reference to the processing illustrated in FIG. 7, the preliminary feed of fibers 270 may comprise virgin fibers and/or may comprise recycled fibers. In preferred implementations of the processing of FIG. 7, the preliminary feed of fibers 270 includes recycled fibers (e.g., recycled carbon fibers). Such recycled fibers may be obtained from any source for feed to the processing 200, and may optionally be prepared through performance of the optional recycle processing 300 to recover recycled fibers from a composite material feed 302. The composite material feed 302 to the optional recycle processing 300 may comprise scrap and/or waste of fiber-reinforced material that is processed in the recycle processing 300 to free recycled fibers from matrix of the composite material feed 302 and recovery of recycled reinforcing fibers for use in the preliminary feed of fibers 270 to prepare the fiber-containing bulk product 272. The composite material feed 302 may include a matrix of a thermoset polymer composition or thermoplastic polymer composition. A thermoset matrix may include an uncured thermoset resin (e.g., prepreg) or a cured thermoset polymer composition. The recycling processing 300 may include any processing technique for separating reinforcing fibers from the matrix of the composite material feed 302. Some example processing techniques include pyrolysis, solvation, or depolymerization of the matrix to free the fibers for recovery. Some preferred implementations of the recycle processing 300 include processing disclosed in any of U.S. Pat. Nos. 10,487,191; 10,610,911 and 10,829,611. In some such preferred implementations of the recycle processing 300, the composite material feed 302 is subjected to first treating with a first, normally-liquid solvent to dissolve matrix material and free fibers for recovery, followed by separating first solvent loaded with dissolved matrix material from freed fibers and then followed by second treating the freed fibers with a second solvent, typically of normally-gaseous material such as carbon dioxide, to remove a residual portion of first solvent.

FIG. 9 shows a general process diagram of an example of such processing that may be performed during the optional recycle processing 300 to process the composite material feed 302 to prepare the preliminary feed of fibers 270 containing recycled fibers for feed to the processing 200. As seen FIG. 9, the composite material feed 302 is subjected to first treating 304, during which the composite material feed 302 is contacted with a first solvent 306, preferably a normally-liquid solvent, to dissolve most or even essentially all of matrix material from the composite material feed 302, leaving reinforcing fibers freed from the composite structure. A resulting mixture 308 including first solvent loaded with dissolved matrix material and freed reinforcing fibers is then subjected to liquid-solid separation 310, during which most, and preferably all but a small residual amount, of the loaded first solvent is recovered in a separated liquid 312 and most, and preferably essentially all, of the freed fibers are recovered in a solid residue 314, which also includes a residual amount of the first solvent. The solid residue 314 is then subjected to second treating 316, during which the solid residue 314 is contacted with a second solvent 318, which is a solvent for the first solvent and not a solvent for the reinforcing fibers. A loaded second solvent 320, containing a dissolved residual portion of the first solvent, and a dried solid residue 322, containing freed reinforcing fibers from which the residual portion of the first solvent has been removed, are recovered from the second treating 316. The dried solid residue 322 may be used directly as recovered from the second treating 316 as the preliminary feed of the fibers 270 to the processing 200, or may be further processed as desired to prepare the preliminary feed of the fibers 270.

As used herein, the term “bulk product” refers to a product in particulate form, for example in the form of a powder, lumps or granules, including intra-particle and inter-particle voids. The term may be used interchangeably with the term “bulk material”.

As used herein, the term “bulk density” refers to the apparent density of a quantity of bulk product. Bulk density may be determined by dividing the mass of the quantity of the bulk product by the volume occupied by the quantity of the bulk product, including intra-particle and inter-particle voids.

As used herein, the terms “untapped bulk density” and “free settling bulk density” are interchangeable and refer to bulk density of a quantity of bulk product determined according to the following procedure, which is similar to but modified relative to ASTM Standard D7481-18:
Weigh and record the weight in grams of a clean, empty, 0.5 L straight-walled beaker. The beaker may be procured, for example from a Cole-Parmer graduated Griffin Beaker #SK-34502-46, or an equivalent container.
Fill the graduated beaker to the top graduation by gently sifting particles of the bulk product from a container into the beaker, ensuring a neutral fill. A funnel may be used if desired or convenient, to ensure a neutral fill.
Weigh in grams the filled beaker and determine the weight of particles in the beaker as the difference in weight relative to the empty beaker, to an accuracy of at least 0.1 gram. The difference in weight may be determined directly by zeroing the balance to the tare weight of the empty beaker before adding the bulk product, or the total weight of the beaker and bulk product may be determined and the weight of the particles in the filled beaker may be determined by difference relative to the weight of the empty beaker.
The bulk density (in grams per liter) is equal to two times the determined weight of the particles in the filled beaker.

As used herein the term “tapped bulk density” refers to bulk density of a quantity of bulk product determined according to the following procedure, which is also similar to but modified relative to ASTM Standard D7481-18:
First complete the steps noted above for determining untapped bulk density.
Then move the filled beaker to a hard surface, such as the surface table or counter, and repeatedly tap the bottom of the beaker on the surface by repeatedly lifting the beaker 1-2 centimeters off of the surface and letting it fall back to the surface at a frequency of approximately 90 taps per minute.
Continue the tapping until the settled volume of the bulk product in the beaker remains essentially constant (within approximately 2%) for at least 10 taps.
Measure the settled volume of the bulk product in the beaker to the nearest 5 milliliters.
Determine the tapped bulk density (in grams per liter) by dividing the weight in grams of the bulk product, determined during prior processing to determine untapped bulk density, by the measured settled volume in liters of the bulk product.

As used herein, “angle of repose” of a bulk product refers to an angle of repose of a stacked pile of the bulk product determined by the following procedure, which is similar to but modified relative to ASTM Standard C 1444-00:
Provide a funnel of sufficient size to hold a 150 gram sample of the bulk product and with the funnel having an outlet diameter of 2.75 inches (6.9 centimeters). For example, the funnel may be a standard 48 oz plastic long neck funnel Model #LX-1614 as sold by Home Depot or equivalent. Any given funnel may need to be truncated to provide the appropriate outlet size.
With the outlet covered by a planar object, such as a flat piece of cardboard, pour 150 grams of the bulk product into the funnel.
With the funnel outlet held at a height of 4.5 inches (11.4 centimeters) above a clean sheet of paper (e.g., clean sheet of printer paper), remove the cover from the funnel outlet and permit the bulk product to flow out of the funnel outlet and to form a pile on the sheet of paper. The funnel should be held on a stand configured not to interfere with development of the pile. A cylindrical cardboard stand of 10 inches (25.4 centimeters) diameter has generally been adequate for bulk products of the fiber-containing particles of this disclosure.
After flow of the bulk product from the funnel has ceased and the pile of the bulk product has stopped settling, measure and record two perpendicular diameters of the base of the stack and measure the height of the stack, each to the nearest 0.25 inch (0.64 centimeter), and average the measured diameters.
Calculate the angle of repose, as follows:

AR=tan−1(2h/d)

where, AR is the angle of repose, h is the height of the pile and d is the averaged diameter of the base of the pile.

### EXAMPLES

### Example 1

Batches of fiber-containing particles are prepared generally according to the following procedure:
1. A feed of recycled carbon fibers previously recovered from a prepreg composite was cut using a guillotine chopping machine set at a 3 millimeter, 6 millimeter or 12 millimeter cut setting. As will be appreciated, cut fibers may be longer or smaller than the cut setting based on how long the original fiber was before being cut by the guillotine cutting blade and the angle at which the fiber was disposed relative to the cutting blade when it was cut. To obtain greater uniformity in cut length of fibers, the fiber was processed through the chopper three or four times.
2. From 10 to 30 kilograms of the final chopped fibers were poured into a 55 gallon drum and then water and binder material were added to form a mixture with the chopped fibers, with the mixture containing 20 to 35 weight percent water, 1 to 5 weight percent binder material and the balance being the chopped fibers. Some example binders that were tested are listed in Table 1. The water and binder material were pre-mixed and the water and binder mixture was poured over the fibers in the 55 gallon drum. Generally, a greater weight percentage of water was added for chopped fibers prepared at the 3 millimeter chop setting and a smaller weight percentage of water was added for chopped fibers prepared at the 6 millimeter chop setting or 12 millimeter chop setting. After adding the water and binder mixture, the drum was closed.
3. The closed drum was placed on a drum roller and the drum with the contents were rolled for a total time of about 120 to 210 minutes with the rotational speed of the drum roller set at 24 revolutions per minute, which equates to a tangential speed of about 0.7 meters per second at the inner wall of the drum cylinder. Rolling of the drum was briefly interrupted about every 30 minutes to check the agglomeration progress and to scrape excess fiber off the walls of the drum.
4. Agglomerates resulting from the drum rolling of step 3 were removed from the drum and classified using a vibrating screen sorter operated with a screen having screen openings sized at ¼ inch (6.35 mm), ⅜ inch (9.53 mm) or ½ inch (12.7 mm) to remove oversize particles not passing through the screen.
5. The classified agglomerates were dried in an oven at 300° F. (149° C.) for 8 to 12 hours, to remove essentially all water.

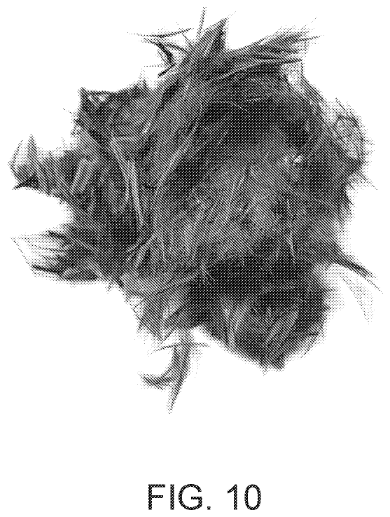

FIG. 10 is a photographic image of an example of recycled carbon fibers prior to chopping. As seen in FIG. 10, the recycled carbon fibers are in a cotton ball-like structure including significant randomness in orientation of the carbon fibers.

TABLE 1
Example Tested Binders

| Product Name | Source | Material Type |
|---|---|---|
| Hydrosize U501 | Michelman | Polyurethane |
| | | Dispersion |
| Hydrosize U201 | Michelman | Polyurethane |
| | | Dispersion |
| Hydrosize U2022 | Michelman | Polyurethane |
| | | Dispersion |

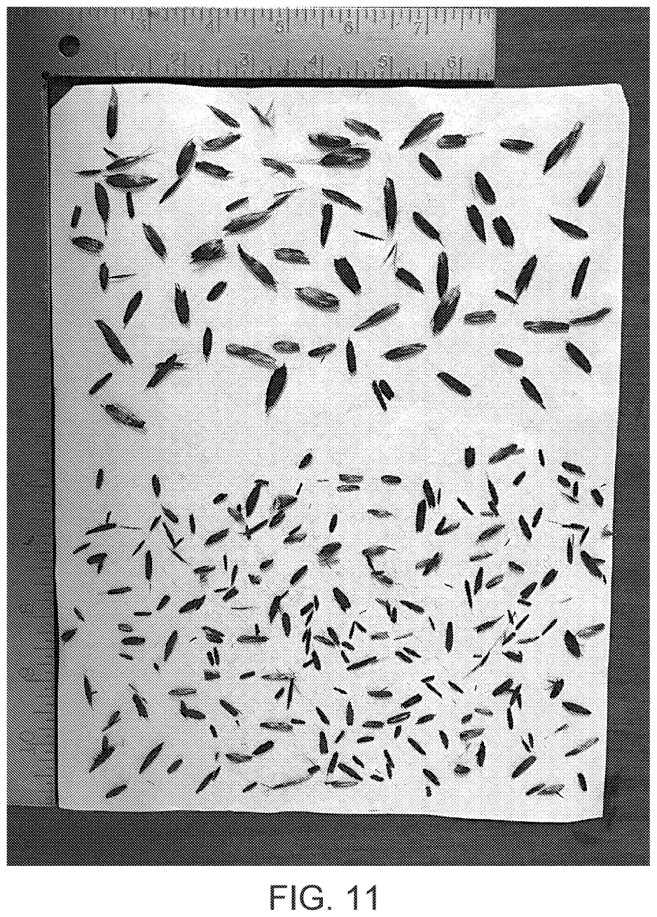

FIG. 11 is a photographic image of two example prepared batches of fiber-containing particles made with recycled carbon fibers and with the fiber-containing particles of each batch dispersed on a white paper background for enhanced visibility of individual particles of each batch. One example batch, shown in the top portion of the image, was prepared with the chopper operated at the 6 millimeter setting and the resulting fiber-containing particles have an average particle length of about 12 millimeters. The other example batch, shown in the bottom portion of the image, was prepared with the chopper operated at the 3 millimeter setting and the resulting fiber-containing particles have an average particle length of about 8 millimeters. In each batch, the elongated shape of the particles and the general alignment of the fibers with the longitudinal direction of the particles is visible, and with many of the particles having a well-developed dual-tapered shape.

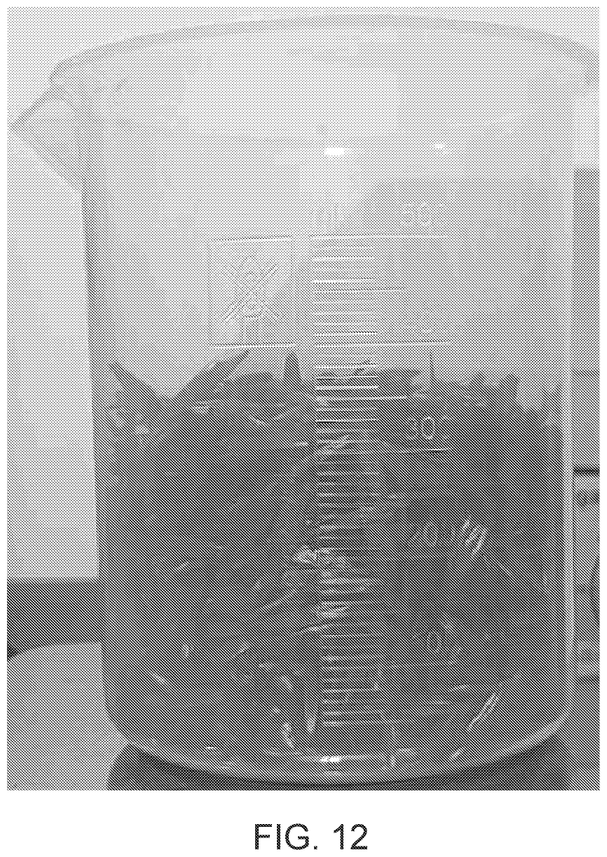

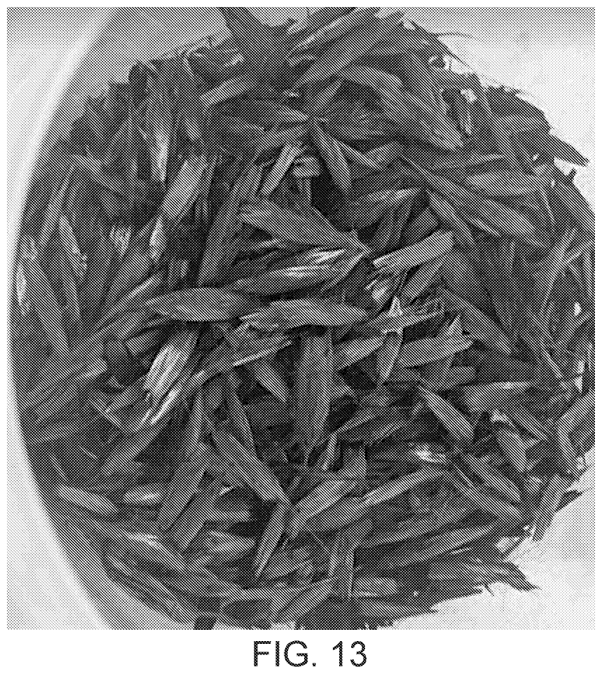

FIG. 12 is a photographic image of a bulk product in a beaker prepared with particles from a batch of fiber-containing particles produced from feed of recycled carbon fibers chopped using the 6 millimeter chopper setting, and FIG. 13 is a photographic image looking down on such a bulk product. This bulk product was tested for bulk density and angle of repose, according to methods described herein. The bulk product had an untapped bulk density of about 200 grams per cubic liter, a tapped bulk density of about 300 grams per cubic liter and an angle of repose of about 36°. These properties indicate good flowability of the bulk product, suitable for feed to an extruder for compounding with polymer.

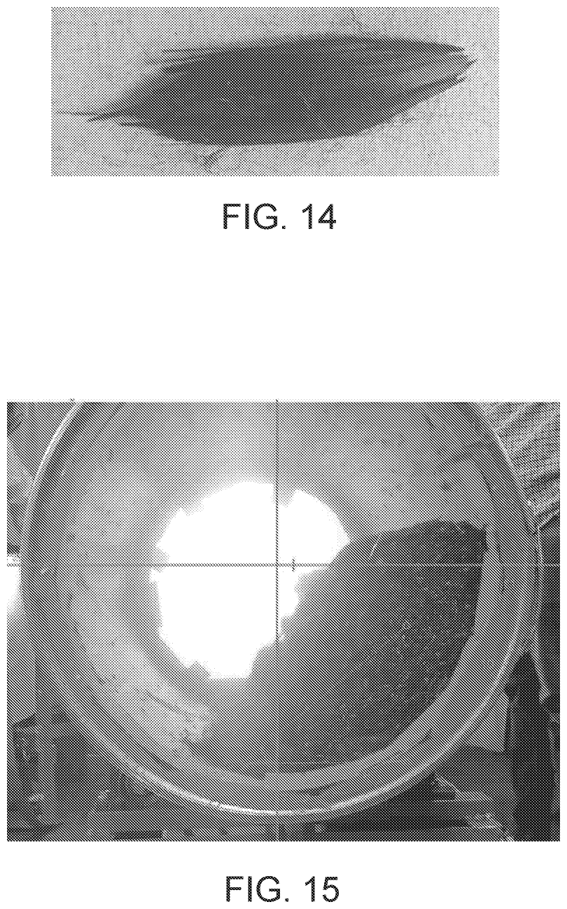

FIG. 14 is a photographic image of a single particle from a batch of fiber-containing particles produced from feed of recycled carbon fibers cut with the 6 mm chopper setting. The particle has a length of about 12 millimeters, with a well-developed dual-tapered particle shape and with a high degree of longitudinal alignment of fibers with the longitudinal direction of the particle. As seen in FIG. 14, the example fiber-containing particle is essentially free of fibers protruding from the particle perpendicular to the longitudinal direction of the particle, which helps facilitate good flowability of such particles in a bulk product.

FIG. 15 is a photographic image showing the inside of a rotating 55-gallon drum with formed agglomerates made from recycled carbon fibers chopped using the 6 millimeter chopper setting, and with the drum fitted with transparent end caps to permit viewing contents within the rotary drum during rotational tumbling.

### Example 2

Extrusion tests were run on batches of fiber-containing particles made with recycled carbon fibers prepared as described in Example 1 to prepare carbon fiber-reinforced composites. Table 2 summarizes some polymers that were tested for compounding with fiber-containing particles prepared with different chopper settings. Each polymer was extruded in a twin-screw extruder. Some samples were extruded in a Leistritz 27 mm twin-screw extruder and other samples were extruded in other extruders. The batches of fiber-containing particles were prepared using a chopper setting at 12 millimeters, 6 millimeters or 3 millimeters. The fiber-containing particles were fed to the extruder from normal bulk handling systems to provide various levels of loading of the recycled percent carbon fiber loading in the extrudate, as summarized in Table 2. Feed to the Leistritz extruder was from a K-Tron T20 vibratory loss-in-weight feeder. The extrudate was passed through a circular die (e.g., two-hole circular die) die and the resulting extrudate strands were cut into cylindrical pellets. The particles generally fed well from feed hoppers and into the extruder during extrusion and with the carbon fibers generally dispersing well from the fiber-containing particles into the polymer melt. Pellets for some of the tests were used as feed to injection molding to prepare molded test coupons of carbon fiber-reinforced material from the pellets. Some extrudate pellets made with polyamide polymer were injection molded to ISO 527-2 Type 1A tensile bars and ISO 197-2 Type D impact specimens. Molded material showed comparable tensile strength, modulus, and impact strength relative to manufacturer specifications for a 40% carbon fiber reinforced commercial compounded material with the same baseline polyamide polymer and virgin carbon fibers. Test specimen molding went smoothly given appropriately high-pressure injection and a heated tool. Some molded test specimens were subjected to XCT (x-ray computed tomography) investigation, which showed similar void and fiber distributions between the test specimens and corresponding baseline commercial compounded material with virgin carbon fibers.

TABLE 2
Example Thermoplastic Polymers Extruded

| | | Chopper | Carbon |
|---|---|---|---|
| | | Setting | Fiber |
| Polymer Product | Polymer | (3 mm, 6 mm, | Loading |
| Name | Type | or 12 mm) | (Weight %) |
| Chase Pryme N100L | Polyamide 6 | 6 mm | 40 |
| BASF Ultramid ® | Polyamide 6,6 | 6 mm | 30 & 40 |
| A3W-Q601 | | | |
| Arkema Rilsan ® | Polyamide 11 | 6 mm & 12 mm | 20, 25 & 30 |
| Braskem F30 | Polypropylene | 6 mm | 15 & 20 |
| | homopolymer | | |
| Formosa Formolene ® | Polypropylene | 3 mm | 10, 20, 30 & |
| 4100N | homopolymer | | 40 |

### Exemplary Implementation Combinations

Some other contemplated embodiments of implementation combinations for various aspects of this disclosure, with or without additional features as disclosed above or elsewhere herein, are summarized in the numbered paragraphs presented below, and in the appended claims:
1. A method of making a bulk product comprising fiber-containing particles with reinforcing fibers held in a particle structure by binder, the method comprising:
preliminary processing of reinforcing fibers to prepare a non-continuous fiber feed of non-continuous reinforcing fibers;
preparing agglomerates including at least a portion of the non-continuous reinforcing fibers of the non-continuous fiber feed and binder material, comprising combining the non-continuous fiber feed and the binder material in a process mixture and tumbling the process mixture; and
wherein the preliminary processing comprises:
   size classifying a mixture of non-continuous reinforcing fibers to prepare a plurality of fiber fractions including at least a first fiber fraction having a first weight average fiber length and a second fiber fraction having a second weight average fiber length, wherein the second weight average fiber length is larger than the first weight average fiber length; and
   preparing the non-continuous fiber feed to include at least a portion of non-continuous reinforcing fibers of the first fiber fraction.
2. A method of making a bulk product comprising fiber-containing particles with reinforcing fibers held in a particle structure by binder, the method comprising:
preliminary processing of reinforcing fibers to prepare a non-continuous fiber feed of non-continuous reinforcing fibers;
preparing agglomerates including at least a portion of the non-continuous reinforcing fibers of the non-continuous fiber feed and binder material, comprising combining the non-continuous fiber feed and the binder material in a process mixture and tumbling the process mixture; and
wherein the preliminary processing comprises:
   increasing longitudinal alignment between the reinforcing fibers to prepare an aligned fiber feed; and
   preparing the non-continuous fiber feed to include at least a portion of the reinforcing fibers of the aligned fiber feed.
3. A method of making a bulk product comprising fiber-containing particles with reinforcing fibers held in a particle structure by a binder, the method comprising:
production processing, comprising:
   (i) preparing agglomerates, comprising tumbling a process mixture comprising non-continuous reinforcing fibers and a binder material to form agglomerates including at least a portion of the non-continuous reinforcing fibers and at least a portion of the binder material, and wherein the agglomerates have a particle structure comprising:
      a particle length dimension, being a maximum separation distance in a longitudinal direction between first and second longitudinal ends of the agglomerate;
      a maximum particle width dimension transverse to the longitudinal direction at a longitudinal location between the first and second longitudinal ends; and
      an aspect ratio equal to the particle length dimension divided by the maximum particle width dimension; and
   (ii) subjecting the agglomerates to size classification to prepare a plurality of agglomerate fractions, the plurality of agglomerate fractions including at least a first agglomerate fraction having a first weight average particle length dimension and a second agglomerate fraction having a second weight average particle length dimension, wherein the first weight average particle length dimension is smaller than the second weight average particle length dimension; and
   (iii) processing at least a portion of the agglomerates of the first agglomerate fraction to provide fiber-containing particles with the particle structure for inclusion in a bulk product; and
reprocessing the non-continuous fibers and the binder material of at least a portion of the second agglomerate fraction, the reprocessing comprising:
   (a) subjecting at least a portion, and preferably all, of the agglomerates of the second agglomerate fraction to length reduction processing to reduce the length of at least a portion of the non-continuous reinforcing fibers of the second agglomerate fraction to prepare reprocessed non-continuous reinforcing fibers, and optionally the length reduction processing comprises subjecting at least a portion of the second agglomerate fraction to one or more cutting operations; and
   (b) subjecting to a reprocessing occurrence of the production processing at least a portion of the reprocessed non-continuous reinforcing fibers from the second agglomerate fraction and at least a portion of the binder material from the second agglomerate fraction in the process mixture of the reprocessing occurrence of the production processing.
4. The method of paragraph 3, wherein the second weight average particle length dimension is at least 1.25 times as large as the first weight average particle length dimension, or at least 1.5 times as large as the first weight average particle length dimension, or even at least 2.0 times as large as the first weight average particle length dimension, and optionally the second weight average particle length dimension is not larger than 10 times as large as the first weight average particle length dimension.
5. The method of either one of paragraph 3 or paragraph 4, wherein the first weight average particle length is in a range of from 3 millimeters to 40 millimeters.
6 The method of any one of paragraphs 3-5, wherein the first agglomerate fraction comprises a first weight average aspect ratio and the second agglomerate fraction comprises a second weight average aspect ratio, and the second weight average aspect ratio is larger than the first weight average aspect ratio.
7. The method of paragraph 6, wherein the second weight average aspect ratio is at least 1.25 times as large as the first weight average aspect ratio, or at least 1.5 times as large as the first weight average aspect ratio, or even at least 2.0 times as large as the first weight average aspect ratio, and optionally the second weight average aspect ratio is not larger than 10 times as large as the first weight average aspect ratio.
8. The method of any one of paragraphs 3-7, wherein the process mixture of the reprocessing occurrence of the production processing comprises a weight ratio of the binder material to the reprocessed non-continuous reinforcing fibers that is within a range of from 0.9 to 1.1, and preferably is the same as, a weight ratio of the binder material to the non-continuous fibers in the second agglomerate fraction.
9 The method of any one of any one of paragraphs 3-8, wherein the process mixture of the reprocessing occurrence of the production processing comprises a quantity of the reprocessed non-continuous reinforcing fibers equal to at least 90 mass percent, and preferably includes all, of the mass of the non-continuous reinforcing fibers of the second agglomerate fraction and a quantity of the binder material equal to at least 90 mass percent, and preferably includes all, of the mass of the binder material of the second agglomerate fraction.
10. The method of any one of paragraphs 3-9, wherein:
the process mixture of the production processing comprises water, in addition to the non-continuous reinforcing fibers and the binder material, to prepare the agglomerates comprising water from the process mixture; and
the process mixture of the reprocessing occurrence of the production processing comprises water from the second agglomerate fraction.
11. The method of paragraph 10, wherein the at least a portion of the second agglomerate fraction subjected to the length reduction processing comprises water at a concentration in a range of from a lower limit of 5 weight percent, preferably 10 weight percent and more preferably 15 weight percent and an upper limit of 50 weight percent, preferably 35 weight percent and more preferably 30 weight percent.
12. The method of either one of paragraph 10 or paragraph 11, wherein the process mixture of the reprocessing occurrence of the production processing comprises water from the second agglomerate fraction at a concentration in a range of from a lower limit of 5 weight percent, preferably 10 weight percent and more preferably 15 weight percent and an upper limit of 50 weight percent, preferably 35 weight percent and more preferably at least 30 weight percent
13. The method of paragraph 12, wherein the process mixture of the reprocessing occurrence of the production processing comprises only water from the second agglomerate fraction.
14. The method of paragraph 12, wherein the process mixture of the reprocessing occurrence of the production processing comprises added water in addition to the water from the second agglomerate fraction.
15. The method of any one of paragraphs 3-14, wherein the non-continuous reinforcing fibers in the process mixture of the reprocessing occurrence of the production processing comprises only the reprocessed non-continuous reinforcing fibers prepared from the at least a portion of the second agglomerate fraction as the non-continuous reinforcing fibers in the process mixture.
16. The method of any one of paragraphs 3-15, wherein the binder material in the process mixture of the reprocessing occurrence of the production processing comprises only the binder material from the at least a portion of the second agglomerate fraction.
17. The method of any one of paragraphs 3-14, wherein the non-continuous reinforcing fibers in the process mixture of the reprocessing occurrence of the production processing comprise non-continuous reinforcing fibers other than the reprocessed non-continuous reinforcing fibers prepared from the at least a portion of the second fraction.
18. The method of paragraph 17, wherein the other non-continuous reinforcing fibers comprise non-continuous reinforcing fibers provided to the reprocessing occurrence of the production processing in a non-continuous fiber feed in dry form.
19. The method of any one of paragraphs 3-18, wherein the production processing comprises preparing the process mixture prior to the tumbling.
20. The method of any one of paragraphs 3-19, comprising subjecting to an occurrence of the reprocessing the non-continuous fibers and the binder material of at least a portion of a said second agglomerate fraction prepared during the reprocessing occurrence of the production processing.
21. The method of any one of paragraphs 3-20, wherein for each occurrence of the production processing, the process mixture comprises only non-continuous reinforcing fibers that have not been previously subjected to the reprocessing more than 5 times, preferably have not been previously subjected to the reprocessing more than 4 times and more preferably have not been previously subjected to the reprocessing more than 3 times previously.
22. The method of any one of paragraphs 3-21, wherein the bulk product of an occurrence of the production processing and the bulk product of a following said reprocessing occurrence of the production processing are prepared and maintained as separate bulk products, and optionally are packaged, for example in bags or other packaging containers, in separate product packaging.
23. The method of any one of paragraphs 3-21, wherein at least a portion of the bulk product of an occurrence of the production processing and at least a portion of the bulk product of a following said reprocessing occurrence of the production processing are combined in a combined bulk product.
24. The method of any one of paragraphs 3-23, wherein the first agglomerate fraction comprises water at a concentration in a range of from a lower limit of 5 weight percent, preferably 10 weight percent and more preferably 15 weight percent and an upper limit of 50 weight percent, preferably 35 weight percent and more preferably 30 weight percent.
25. The method of any one of paragraphs 3-24, wherein the plurality of agglomerate fractions include a third agglomerate fraction having a third weight average particle length dimension and the third weight average particle length dimension is larger than the first weight average particle dimension and smaller than the second weight average particle dimension.
26. The method of paragraph 25, comprising subjecting at least a portion of the third agglomerate fraction to the reprocessing, optionally separately from the at least a portion of the second agglomerate fraction subjected to the reprocessing and alternatively optionally together with the at least a portion of the second agglomerate fraction subjected to the reprocessing.
27. The method of any one of paragraphs 3-26, comprising an initial occurrence of the production processing in which at least a portion of the non-continuous fibers for the process mixture are provided to the initial occurrence of the production processing in a non-continuous fiber feed in dry form; and wherein the method comprises preliminary processing of reinforcing fibers to prepare the non-continuous fiber feed.
28. The method of either one of paragraph 2 or paragraph 27, wherein the preliminary processing comprises:
size classifying a mixture of non-continuous reinforcing fibers to prepare a plurality of fiber fractions including at least a first fiber fraction having a first weight average fiber length and a second fiber fraction having a second weight average fiber length, wherein the second weight average fiber length is larger than the first weight average fiber length; and
preparing the non-continuous fiber feed to include at least a portion of non-continuous reinforcing fibers of the first fiber fraction.
29. The method of either one of paragraph 1 or paragraph 28, wherein the second weight average fiber length is at least 1.25 times as large as the first weight average fiber length, or at least 1.5 times as large as the first weight average fiber length, or even at least 2.0 times as large as the first weight average fiber length, and optionally the second weight average fiber length is not larger than 10 times as large as the first weight average fiber length.
30. The method of any one of paragraphs 1, 28 and 29, wherein the first weight average fiber length is at least 1 millimeter, preferably at least 2 millimeters, more preferably at least 3 millimeters, or even at least 4 millimeters, or at least 6 millimeters or at least 9 millimeters.
31. The method of any one of paragraphs 1 and 28-30, wherein the first weight average fiber length is not larger than 18 millimeters, preferably not larger than 12 millimeters, more preferably not larger than 8 millimeters, or even not larger than 6 millimeters, and with one preferred range for the first weight average fiber length being from 3 millimeters to 8 millimeters and another preferred range being from 4 millimeters to 12 millimeters.
32. The method of any one of paragraphs 1 and 28-31, wherein the plurality of fiber fractions include a third fiber fraction having a third weight average fiber length, wherein the third weight average fiber length is smaller than the first weight average fiber length.
33. The method of paragraph 32, wherein the first weight average fiber length is at least 1.25 times as large as the third weight average fiber length, or at least 1.5 times as large as the third weight average fiber length, or even at least 2.0 times as large as the first weight average fiber length, and optionally the first weight average fiber length is not larger than 50 times as large as the third weight average fiber length.
34. The method of either one of paragraph 32 or paragraph 33, wherein the third weight average fiber length is not larger than 2 millimeters, or is not larger than 1.5 millimeters, or is not larger than 1 millimeter, and optionally the third weight average fiber length is at least 0.1 millimeter.
35. The method of any one of paragraphs 32-34, comprising excluding at least a portion, and preferably all, of the third fiber fraction from the non-continuous fiber feed and from the agglomerates.
36 The method of any one of paragraphs 1 and 28-35, wherein at least a portion of the first fiber fraction, and preferably all of the first fiber fraction, forms at least a part of the non-continuous fiber feed, and optionally without fiber modification after the size classifying and before inclusion in the non-continuous fiber feed.
37. The method of any one of paragraphs 1 and 28-36, wherein at least a portion of the first fiber fraction, and preferably all of the first fiber fraction, forms at least part of the non-continuous fiber feed, and wherein the processing at least a portion of the first fiber fraction to prepare the non-continuous fiber feed is in the absence of length reduction processing of fibers of the first fiber fraction.
38. The method of any one of paragraphs 1 and 28-37, wherein the non-continuous fiber feed is prepared with a weight average fiber length in the non-continuous fiber feed of at least 1 millimeter, preferably at least 2 millimeters, more preferably at least 3 millimeters, or even at least 4 millimeters, or at least 6 millimeters or at least 9 millimeters.
39. The method of any one of paragraphs 1 and 28-38, wherein the non-continuous fiber feed is prepared with a weight average fiber length in the non-continuous fiber feed of not larger than 18 millimeters, preferably not larger than 12 millimeters, more preferably not larger than 8 millimeters or even more preferably not larger than 6 millimeters, and with one preferred range for the first weight average fiber length being from 3 millimeters to 8 millimeters and another preferred range being from 4 millimeters to 12 millimeters.
40. The method of any one of paragraphs 1 and 28-39, comprising subjecting at least a portion of the second fiber fraction to fiber length reduction to prepare reduced-length fibers, optionally comprising cutting fibers of the second fiber fraction.
41. The method of paragraph 40, comprising preparing the non-continuous fiber feed to include at least a portion of the reduced-length fibers.
42. The method of paragraph 41, comprising recycling at least a portion of the reduced-length fibers to be included in the mixture of non-continuous reinforcing fibers subjected to the size classifying.
43. The method of any one of paragraphs 1 and 28-42, comprising preparing the mixture of noncontinuous fibers, the preparing the mixture of noncontinuous fibers comprising subjecting a preliminary mixture of reinforcing fibers to length reduction processing, optionally including one or more than one cutting steps, and wherein a weight average fiber length of the mixture of non-continuous reinforcing fibers is smaller than a weight average fiber length of the preliminary mixture of reinforcing fibers.
44. The method of paragraph 43, comprising recycling at least a portion of the second fiber fraction to the preliminary mixture of reinforcing fibers, and wherein the mixture of non-continuous reinforcing fibers comprises reduced-length fibers prepared from recycled fibers of the second fiber fraction.
45. The method of paragraph 40, wherein the non-continuous fiber feed is a first non-continuous fiber feed, the agglomerates are first agglomerates, the binder material is a first binder material, the reinforcing fibers are first reinforcing fibers, the process mixture is a first process mixture and the tumbling is first tumbling, and the method comprises:
preparing a second non-continuous fiber feed separate from the first non-continuous fiber feed, the second non-continuous fiber feed including second reinforcing fibers comprising at least a portion, and preferably all, of the reduced-length fibers; and
preparing second agglomerates including at least a portion of the second non-continuous reinforcing fibers of the second non-continuous fiber feed and the second binder material, comprising combining the second non-continuous fiber feed and the second binder material in a second process mixture and second tumbling the process mixture;
and optionally the second binder material is the same composition as the first binder material or further optionally is a different composition than the first binder material.
46. The method of paragraph 45, wherein any of the second non-continuous fiber feed, second agglomerates, second binder material, second reinforcing fibers, and second tumbling comprise features or characteristics described for the first agglomerates, first binder material, first reinforcing fibers, first tumbling or first process mixture, respectively, of any of the preceding or following numbered paragraphs.
47. The method of any one of paragraphs 1 and 28-46, wherein the size classifying comprises air classification, vibratory sorting or screening or any combinations thereof.
48. The method of any one of paragraphs 1 and 27-47, wherein the preliminary processing comprises:
increasing longitudinal alignment of reinforcing fibers relative to each other to prepare an aligned fiber feed; and
preparing the non-continuous fiber feed to include at least a portion of the reinforcing fibers of the aligned fiber feed.
49. The method of either one of paragraph 2 or paragraph 48, wherein the preparing the non-continuous fiber feed comprises, prior to the increasing longitudinal alignment of the reinforcing fibers, subjecting the reinforcing fibers to an upstream length reduction operation to reduce weight average length of the reinforcing fibers prior to the increasing longitudinal alignment, and optionally the upstream length reduction operation comprises a cutting operation and preferably with a cutting blade disposed transverse to a machine direction of travel of the reinforcing fibers through the upstream cutting operation.
50. The method of either one of paragraphs 2, 48 and 49, wherein the preparing the non-continuous fiber feed comprises subjecting the reinforcing fibers in the aligned fiber feed to a downstream length reduction operation to reduce weight average length of the reinforcing fibers, and optionally the downstream length reduction operation comprises a cutting operation and preferably with a cutting blade disposed transverse to a machine direction of travel of the reinforcing fibers through the downstream cutting operation.
51. The method of paragraph 50, wherein the preparing the non-continuous fiber feed comprises:
size classifying a mixture of non-continuous reinforcing fibers from the downstream reduction operation to prepare a plurality of fiber fractions including at least a first fiber fraction having a first weight average fiber length and a second fiber fraction having a second weight average fiber length, wherein the second weight average fiber length is larger than the first weight average fiber length; and
preparing the non-continuous fiber feed to include at least a portion of non-continuous reinforcing fibers of the first fiber fraction
52. The method of either one of paragraph 50 or paragraph 51, wherein the increasing longitudinal alignment of the reinforcing fibers increases longitudinal alignment of the reinforcing fibers relative to a machine direction of travel of the reinforcing fibers toward the downstream length reduction operation.
53. The method of any one of paragraphs 2 and 48-52, wherein the increasing longitudinal alignment comprises contacting at least a portion of the reinforcing fibers during conveyance with alignment channels extending longitudinally in a machine direction of conveyance of the reinforcing fibers, wherein the alignment channels are configured to increase alignment between the reinforcing fibers and optionally also configured to increase longitudinal alignment of the reinforcing fibers relative to a machine direction of travel of the reinforcing fibers during the increasing longitudinal alignment.
54. The method of paragraph 53, wherein the alignment channels comprise channels on a vibratory conveyor.
55. The method of either one of paragraph 53 or paragraph 54, wherein the alignment channels have a channel width perpendicular to the machine direction of conveyance of at least 1 millimeter, at least 2 millimeters, at least 4 millimeters or at least 6 millimeters.
55.1 The method of any one of paragraphs 53-55, wherein the alignment channels have a channel width perpendicular to the machine direction of conveyance of not larger than 45 millimeters, not larger than 30 millimeters, not larger than 20 millimeters or not larger than 10 millimeters, and with one preferred range for the width of the alignment channels being from 2 millimeters to 10 millimeters.
56. The method of any one of paragraphs 53-55.1, wherein the alignment channels have a channel length longitudinally in the machine direction of conveyance of at least 20 centimeters, at least 30 centimeters, at least 50 centimeters or at least 75 centimeters.
56.1 The method of any one of paragraphs 53-56, wherein the alignment channels have a channel length longitudinally in the machine direction of conveyance of not longer than 500 centimeters, not longer than 300 centimeters, not longer than 200 centimeters or not longer than 100 centimeters, and with one preferred range for the length of the alignment channels being from 75 centimeters to 100 centimeters.
56.2 The method of any one of paragraphs 2 and 48-56.1, wherein the increasing longitudinal alignment comprises contacting at least a portion of the reinforcing fibers during conveyance with alignment slots extending longitudinally in a machine direction of conveyance of the reinforcing fibers, wherein the alignment slots are configured for passage therethrough of reinforcing fibers to increase alignment of the reinforcing fibers passing through the alignment slots, and optionally the alignment slots are also configured to increase longitudinal alignment of the reinforcing fibers passing through the slots relative to a machine direction of travel of the reinforcing fibers during the increasing longitudinal alignment.
56.3. The method of paragraph 56.2, wherein the alignment slots comprise slots in a vibratory conveyor.
56.4. The method of either one of paragraph 56.2 or paragraph 56.3, wherein the alignment slots have a slot width perpendicular to the machine direction of conveyance of at least 2 millimeters, at least 3 millimeters, at least 4 millimeters or at least 5 millimeters.
56.5 The method of any one of paragraphs 56.2-56.4, wherein the alignment slots have a slot width perpendicular to the machine direction of conveyance of not larger than 45 millimeters, not larger than 30 millimeters, not larger than 20 millimeters or not larger than 10 millimeters, and with one preferred range for the alignment slots being from 5 millimeters to 10 millimeters.
56.6 The method of any one of paragraphs 56.2-56.5, wherein the alignment slots have a slot length longitudinally in the machine direction of conveyance of at least 20 centimeters, at least 30 centimeters, at least 50 centimeters or at least 75 centimeters.
56.7 The method of any one of paragraphs 56.2-56.6, wherein the alignment slots have a slot length longitudinally in the machine direction of conveyance of not longer than 500-centimeters, not longer than 300 centimeters, not longer than 200 centimeters or not longer than 100 centimeters, and with one preferred range for the length of the alignment slots being from 75 centimeters to 100 centimeters.
57. The method of any one of paragraphs 2 and 48-56.7, wherein the increasing longitudinal alignment of the reinforcing fibers comprises increasing the longitudinal alignment of the reinforcing fibers from a first alignment to a second alignment, wherein in the second alignment the reinforcing fibers are more aligned with a machine direction of conveyance of the reinforcing fibers.
57.1 The method of paragraph 57, wherein in the first alignment at least 30 length percent of the reinforcing fibers, or even at least 40 length percent of the reinforcing fibers, have a longitudinal orientation at an alignment angle between 45° and 90° relative to the machine direction of conveyance and in the second alignment not more than 20 length percent of the reinforcing fibers, or even not more than 10 length percent of the reinforcing fibers, have a longitudinal orientation at an alignment angle between 45° and 90° relative to the machine direction of conveyance.
57.2 The method of either one of paragraph 57 or paragraph 57.1, wherein in the first alignment at least 15 weight percent of the reinforcing fibers, or even at least 20 length percent of the reinforcing fibers have a longitudinal orientation at an alignment angle between 60° and 90° relative to the machine direction of conveyance and in the second alignment not more than 10 weight percent of the reinforcing fibers, or even not more than 5 length percent of the reinforcing fibers, have a longitudinal orientation at an alignment angle between 60° and 90° relative to the machine direction of conveyance.
57.3 The method of any one of paragraphs 57-57.2, wherein in the first alignment not more than 40 length percent of the reinforcing fibers, or even not more than 35 length percent of the reinforcing fibers, have a longitudinal orientation at an alignment angle between 0° and 30° relative to the machine direction of conveyance and in the second alignment at least 70 length percent of the reinforcing fibers, or even at least 80 length percent of the reinforcing fibers, have a longitudinal orientation at an alignment angle between 0° and 30° relative to the machine direction of conveyance.
57.4 The method of any one of paragraphs 57-57.3, wherein in the first alignment the reinforcing fibers have a length average alignment angle relative to the machine direction of conveyance of greater than 35°, or even greater than 40°, and in the second alignment the reinforcing fibers have a length average alignment angle relative to the machine direction of conveyance of not larger than 20°, or even not larger than 10°.
58. The method of any one of paragraphs 2 and 48-57.4, wherein the preparing the fiber feed comprises, after the increasing longitudinal alignment:
size classifying the reinforcing fibers to prepare a plurality of fiber fractions including at least a first fiber fraction having a first weight average fiber length and a second fiber fraction having a second weight average fiber length, wherein the second weight average fiber length is larger than the first weight average fiber length; and
preparing the non-continuous fiber feed to include at least a portion of non-continuous reinforcing fibers of the first fiber fraction.
59. The method of any one of paragraphs 1, 2 and 27-58, wherein the preliminary processing of reinforcing fibers comprises cutting the reinforcing fibers to prepare cut fibers and preparing the fiber feed to include at least a portion of the cut fibers.
60. The method of any one of paragraphs 1, 2 and 27-59, wherein a preliminary fiber feed to the preliminary processing comprises recycled reinforcing fibers recovered from composite material.
61. The method of paragraph 60, comprising recovering the recycled reinforcing fibers from the composite material, wherein the recovering the recycled reinforcing fibers comprises freeing the recycled reinforcing fibers from a matrix of the composite, optionally comprising solvation of the matrix of the composite, optionally comprising pyrolysis of the matrix of the composite and optionally comprising depolymerization of the matrix of the composite.
62. The method of any one of paragraphs 1, 2 and 27-61, wherein a weight average fiber length of the reinforcing fibers in the fiber feed is at least 1 millimeter, at least 2 millimeters, at least 3 millimeters, at least 4 millimeters, at least 6 millimeters or even at least 9 millimeters.
63. The method of any one of paragraphs 1, 2 and 27-62, wherein a weight average fiber length of the reinforcing fibers in the fiber feed is not larger than 18 millimeters, 12 millimeters, 8 millimeters or 6 millimeters. One preferred range for the weight average fiber length in the fiber feed is from 3 millimeters to 8 millimeters, with another preferred range being from 4 millimeters to 6 millimeters.
64. The method of any one of paragraphs 1, 2 and 27-63, wherein the reinforcing fibers of the fiber feed are in the absence of fiber sizing.
65. The method of any one of paragraphs 1, 2 and 27-64, wherein the reinforcing fibers comprise fiber sizing, optionally with the fiber sizing in an amount in a range of from 0.5 weight percent to 10 weight percent of the reinforcing fibers, including the weight of the fiber sizing.
66. The method of any one of paragraphs 1-65, wherein the tumbling comprises rotational tumbling, and optionally the preparing agglomerates comprises disposing the reinforcing fibers and the binder material in a process vessel (e.g., rotary drum) and the rotational tumbling comprises rotating the process vessel containing the reinforcing fibers and the binder material.
67. The method of paragraph 66, wherein the rotational tumbling comprises rotating the process vessel with a tangential speed (tip speed) at the inside surface of the rotating wall of the process vessel in a range of from 0.3 to 1.4 meters per second.
68. The method of any one of paragraphs 1-67, wherein the tumbling is performed for a period of time in a range of from 15 minutes to 240 minutes. One more preferred range for the period of time is from 120 minutes to 150 minutes.
69. The method of any one of paragraphs 1-68, wherein feed of the binder material to the preparing agglomerates comprises a binder precursor composition including the binder material dispersed in a carrier liquid.
70. The method of paragraph 69, wherein the binder precursor composition includes at least a portion of the binder material in solids dispersed in the carrier liquid.
71. The method of either one of paragraph 69 or paragraph 70, wherein the preparing agglomerates comprises combining all or a portion of the binder precursor composition with the reinforcing fibers prior to the rotational tumbling (e.g., premixing binder material and reinforcing fibers prior to introduction into the process vessel).
72. The method of any one of paragraphs 69-71, wherein the preparing agglomerates comprises introducing some or all of the binder precursor composition into a process vessel (e.g., rotating drum), optionally while the process vessel is rotating, after the reinforcing fibers are introduced into the process vessel, and optionally the binder precursor composition is sprayed into the process vessel to contact and mix with the reinforcing fibers.
73. The method of any one of paragraphs 69-72, comprising evaporating at least a portion of the carrier liquid after contacting the binder precursor composition with the reinforcing fibers, optionally during and/or after the tumbling, and preferably with at least some, and more preferably a majority, of the evaporating occurring after the rotation tumbling.
74. The method paragraph 73, wherein the evaporating comprises heating the reinforcing fibers and the carrier liquid, optionally to a temperature of at least 100° C., and further optionally within a range of from 100° C. to 200° C. not inclusive of any post-drying heat cure that may be used for some binding systems such as thermoset binder compositions or very high temperature thermoplastic binder compositions. When the method includes curing the binder material, dried agglomerates may be subjected to higher temperatures for the curing than used to dry the agglomerates, for example curing temperatures may exceed 200° C. and may often be in a range of from 200° C. to 380° C. As discussed above, drying and curing may be performed in a single operation (e.g., in a single oven) with the drying occurring during a first stage of heating to within a lower elevated temperature range to remove water by evaporation and the curing may follow in a second stage of heating to within a higher elevated temperature for the curing. Alternatively, drying and curing may be performed as separate operations, (e.g., in separate ovens).
75. The method of any one of paragraphs 69-74, wherein the carrier liquid is an aqueous liquid.
76. The method of any one of paragraphs 1-75, wherein the preparing agglomerates comprises combining the binder material, the reinforcing fibers and water prior to completion of the tumbling, and wherein the water is at a concentration, relative to the total weight of the binder material, the reinforcing fibers and the water, in a range having a lower limit of 10 weight percent and more preferably 20 weight percent and an upper limit of 50 weight percent and more preferably 30 weight percent.
77. The method of any one of paragraphs 1-76, wherein the binder material in the process mixture is in an amount of from 0.5 weight percent to 11 weight percent relative to the weight of the reinforcing fibers.
78. The method of any one of paragraphs 1-77, wherein the binder material in the process mixture is in an amount, relative to the weight of the reinforcing fibers, in a range having a lower limit selected from the group consisting of 0.5 weight percent, 1 weight percent, 2 weight percent, 2.5 weight percent and 3 weight percent and an upper limit selected from the group consisting of 11 weight percent, 9 weight percent, 7 weight percent, 6 weight percent and 5 weight percent. One preferred range is from 2 weight percent to 6 weight percent of the binder material relative to the weight of the reinforcing fibers, and another preferred range is from 2.5 weight percent to 5 weight percent of the binder material relative to the weight of the reinforcing fibers.
79. The method of any one of paragraphs 1-78, wherein the binder material comprises a material selected from the group consisting of polyether polyurethane resin (uncured), polyester polyurethane resin (uncured), maleated polypropylene, polyaryletherketone (PAEK), or epoxy resin (uncured).
80. The method of any one of paragraphs 1-79, comprising drying the agglomerates to prepare dried agglomerates, preferably with the dried agglomerates comprising not more than 0.5 weight percent water, preferably not more than 0.3 weight percent water and more preferably not more than 0.2 weight percent water, and optionally with the dried agglomerates comprising at least 0.001 weight percent water or even at least 0.01 weight percent water.
81. The method of any one of paragraphs 1-80, wherein the tumbling comprises aligning the reinforcing fibers, and wherein the rotational tumbling is performed for a time to align the reinforcing fibers in the agglomerates to an alignment configuration in which at least 70 weight percent, preferably at least 80 weight percent and more preferably at least 85 weight percent, of the reinforcing fibers extend longitudinally within an angle of 20° of a longitudinal direction of the agglomerates, preferably within an angle of 15° and more preferably within an angle of 10° of the longitudinal direction.
82. The method of paragraph 81, comprising after attaining the alignment configuration, drying the agglomerates to remove liquid from the agglomerate particles.
83. The method of any one of paragraphs 1-82, wherein the preparing agglomerates comprises during the tumbling forming the agglomerates as particles with a particle structure, wherein the particle structure comprises:
   a particle length dimension, being a maximum separation distance in a longitudinal direction between first and second longitudinal ends of the particle;
   a maximum particle width dimension transverse to the longitudinal direction at a longitudinal location between the first and second longitudinal ends; and
   an aspect ratio equal to the particle length dimension divided by the maximum particle width dimension; and
recovering a batch of agglomerates comprising at least a portion of the agglomerates as particles of the batch.
84. The method of paragraph 83, comprising processing at least a portion of the batch of agglomerates to prepare a batch of bulk product with a plurality of fiber-containing particles having the particle structure.
85. The method of paragraph 84, wherein the processing at least a portion of the batch of agglomerates comprises drying the at least a portion of the particles of the batch to a water content of no more than 0.5 weight percent water, preferably not more than 0.3 weight percent water and more preferably not more than 0.2 weight percent water, and optionally to a water content of no smaller than 0.001 weight percent water or even no smaller than 0.01 weight percent water.
86. The method of paragraph 85, wherein the drying comprises drying the at least a portion of the first agglomerate fraction at a temperature of at least 100° C., and optionally within a range of from 100° C. to 200° not inclusive of any post-drying heat cure that may be used for some binding systems such as thermoset binder compositions or very high temperature thermoplastic binder compositions.
87. The method of either one of paragraph 85 or paragraph 86, comprising after the drying, curing dried agglomerate particles at a temperature in a range of from 200° C. to 380° C.
88. The method of any one of paragraphs 84-87, wherein for either one or both of the batch of agglomerates and the batch of the bulk product:
at least 25 weight percent the particles of the batch have a dual-tapered shape comprising a first tapered portion tapering in the longitudinal direction away from the longitudinal location toward the first longitudinal end and a second tapered portion tapering in the longitudinal direction away from the longitudinal location toward the second longitudinal end, and optionally at least 50 weight percent, at least 75 weight percent or at least 90 weight percent of the particles of the batch have the duel-tapered shape, and further optionally at least 10 weight percent of the particles of the batch do not have the dual-tapered shape.
89. The method of paragraph 88, wherein the first and second tapered portions each tapers over a longitudinal distance of at least 20 percent (and preferably at least 25 percent) of the longitudinal length within a tapering envelope of a right circular cone with an apex at the respective said longitudinal end and an aperture of no larger than 45°, preferably no larger than 40°, more preferably no larger than 37° and even more no larger than 35°, and preferably in any case the aperture is at least 10°. One preferred range for the aperture is in a range of from 14° to 34°.
90. The method of any one of paragraphs 88-89, wherein for each of the batch of agglomerates and the batch of the bulk product, the batch comprises:
a weight average particle length dimension, being an average on a weight basis of the particle length dimensions of the particles of the batch; and
a weight average aspect ratio, being an average on a weight basis of the aspect ratios of the particles of the batch.
91. The method of paragraph 90, wherein for either one or both of the batch of agglomerates and the batch of the bulk product:
the weight average particle length dimension is in a range having a lower limit selected from the group consisting of 3 millimeters, 3.5 millimeters, 4 millimeters, 5 millimeters and 6 millimeters.
92. The method of either one of paragraphs 90 or paragraph 91, wherein for either one or both of the batch of agglomerates and the batch of the bulk product:
the weight average particle length dimension is in a range having an upper limit selected from the group consisting of 40 millimeters, 30 millimeters, 20 millimeters, 16 millimeters and 14 millimeters. One preferred range for the weight average particle length dimension is from 5 millimeters to 16 millimeters, with an even more preferred range being from 6 millimeters to 14 millimeters.
93. The method of any one of paragraphs 90-92, wherein for either one or both of the batch of agglomerates and the batch of the bulk product:
the particle length dimensions of at least 75 weight percent, preferably at least 80 weight percent, more preferably at least 85 weight percent and even more preferably at least 90 weight percent of the fiber-containing particles are in a range having a lower limit of 0.5 times, and preferably 0.7 times, the weight average particle length dimension and an upper limit of 2 times, and preferably 1.8 times, the weight average particle length dimension.
94. The method of any one of paragraphs 90-93, wherein for either one or both of the batch of agglomerates and the batch of the bulk product:
the particle length dimensions of at least 2 weight percent, or even at least 5 weight percent, or even at least 10 weight percent, of the fiber-containing particles is outside of a range of from 0.8 times the weight average particle length dimension to 1.2 times the weight average particle dimension.
95. The method of any one of paragraphs 90-94, wherein for either one or both of the batch of agglomerates and the batch of the bulk product:
the particle length dimensions of at least 98 weight percent of the fiber-containing particles are no larger than 3 times the weight average particle length dimension.
96. The method of any one of paragraphs 90-95, wherein for either one or both of the batch of agglomerates and the batch of the bulk product:
the weight average aspect ratio is in a range having a lower limit selected from the group consisting of 1.5, 1.7, 1.8 and 1.9.
97. The method of any one of paragraphs 90-96, wherein for either one or both of the batch of agglomerates and the batch of the bulk product:
the weight average aspect ratio is in a range having an upper limit selected from the group consisting of 6, 4 and 3. One preferred range for the weight average aspect ratio is from 1.8 to 4.
98. The method of any one of paragraphs 90-97, wherein for either one or both of the batch of agglomerates and the batch of the bulk product:
the aspect ratios of at least 75 weight percent, preferably at least 80 weight percent, more preferably at least 85 weight percent and even more preferably at least 90 weight percent of the fiber-containing particles are in a range having a lower limit of 1.5 and an upper limit of 4.
99. The method of any one of paragraphs 90-98, wherein for either one or both of the batch of agglomerates and the batch of the bulk product:
the aspect ratios of at least 2 weight percent, or even at least 5 weight percent, of the fiber-containing particles is outside of a range of from 0.8 times to 1.2 times the weight average aspect ratio.
100. A method for making a fiber-reinforced composite, the method comprising:
dispersing the reinforcing fibers from the fiber-containing particles of the batch of bulk product of any one of paragraphs 90-99 in a matrix, preferably a polymeric matrix, and optionally a resulting composite comprises from 5 weight percent to 50 weight percent of the reinforcing fibers, and with one preferred range being from 10 weight percent to 40 weight percent of the reinforcing fibers.
101. The method of paragraph 100, wherein the matrix is a polymeric matrix comprising a thermoplastic polymer.
102. The method of paragraph 101, wherein the thermoplastic polymer includes a member selected from the group consisting of polyamide, polypropylene, polyethylene, polyethylene terephthalate, polylactic acid, polycarbonate, acrylonitrile butadiene styrene, polystyrene and polyaryle ether ketones.
103. The method of either one of paragraph 101 or paragraph 102, wherein the dispersing comprises extruding polymeric material for the matrix and adding the fiber-containing particles of the batch of the bulk product to the polymeric material during the extruding.
104. The method of paragraph 103, comprising pelletizing an extrudate from the extruding, wherein the extrudate comprises the reinforcing fibers dispersed in the matrix, to prepare pellets comprising the reinforcing fibers dispersed in the matrix, and optionally the pellets have a maximum cross dimension (e.g., length dimension) in a range of from 1 millimeters to 25 millimeters, preferably from 4 millimeters to 18 millimeters, and further optionally the pellets have a width dimension, transverse to the maximum cross in a range of from 1 millimeters to 6 millimeters, and preferably in a range of from 2 to 4 millimeters, and preferably the pellets are cylindrically shaped and with a cylinder length and cylinder diameter within the ranges, and preferably within the preferred ranges, for the maximum cross dimension and the width dimension, respectively.
105. The method of paragraph 104, comprising cooling the extrudate prior to the pelletizing.
106. The method of either one of paragraph 104 or paragraph 105, comprising mixing the pellets with at least one other particulate component that is different than the pellets, and optionally such another particular component comprises second pellets of different composition, and further optionally such second pellets comprise second reinforcing fibers, which may the same as or different than the reinforcing fibers of the pellets, dispersed in second matrix, preferably a second polymeric matrix, which may be the same or different than the matrix of the pellets, and wherein such second reinforcing fibers are optionally uniform fiber lengths cut from continuous fibers.
107. The method of any one of paragraphs 104-106, comprising molding material of the pellets into a product form.
108. The method of paragraph 107, wherein the molding comprises injection molding.
109. The method of any one of paragraphs 90-108, wherein the batch of the bulk product has a freely settled (untapped) bulk density in a range with a lower limit selected from the group consisting of 100, 200 or 250 grams per liter and an upper limit selected from the group consisting of 400 grams per liter and 350 grams per liter. One preferred range for the untapped bulk density is in a range of from 200 to 300 grams per liter.
110. The method of any one of paragraphs 84-109, wherein the batch of the bulk product has a tapped bulk density in a range having a lower limit selected from the group consisting of 200, 250 and 300 grams per liter and an upper limit selected from the group consisting of 650 or 600 grams per liter, and optionally the tapped bulk density is in a range of from 1.2 to 2 times as large as the untapped bulk density. One preferred range for the tapped bulk density is in a range of from 250 to 400 grams per liter.
111. The method of any one of paragraphs 90-110, wherein the batch of the bulk product comprises at least 50 weight percent, preferably at least 70 weight percent, more preferably at least 90 weight percent, even more preferably at least 95 weight percent and still more preferably at least 98 weight percent of the fiber-containing particles. The batch of the bulk product may optionally consist of or consist essentially of only the fiber-containing particles.
112. The method of any one of paragraphs 88-111, wherein the batch of the bulk product has an angle of repose in a range having a lower limit of 25° and an upper limit of 45°, with one more preferred range for the angle of repose being in a range of from 30° to 40°.
113. The method of any one of paragraphs 90-112 wherein the batch of the bulk product comprises an amount of the reinforcing fibers in a range having a lower limit selected from the group consisting of 91 weight percent, 92 weight percent and 93 weight percent and an upper limit selected from the group consisting of 99 weight percent, 98 weight percent and 97 weight percent.
114. The method of any one of paragraphs 90-113, wherein the batch of the bulk product comprises binder in an amount in a range having a lower limit selected from the group consisting of 1 weight percent, 2 weight percent, 2.5 weight percent and 3 weight percent and an upper limit selected from the group consisting of 9 weight percent, 7 weight percent, 6 weight percent and 5 weight percent. One preferred range is from 2 weight percent to 6 weight percent of the binder, and another preferred range is from 2.5 weight percent to 5 weight percent of the binder.
115. The method of any one of paragraph 114, wherein the binder comprises a material selected from the group consisting of polyether polyurethane (preferably cured), polyester polyurethane (preferably cured), maleated polypropylene, polyaryletherketone (PAEK), and epoxy polymers (preferably cured).
116. The method of any one of paragraphs 90-115, wherein the batch of the bulk product comprises the reinforcing fibers are in an aligned configuration in the fiber-containing particles with at least 70 weight percent, and preferably at least 80 weight percent and more preferably at least 85 weight percent, of the reinforcing fibers within each of the fiber-containing particles extending longitudinally within an angle of 20° of the longitudinal direction, and preferably with an angle of 10° of the longitudinal direction.
117. The method of any one of paragraphs 90-116, wherein for either one or both of the batch of agglomerates and the batch of the bulk product:
the reinforcing fibers in the batch have a weight average fiber length that is smaller than the weight average particle length dimension, preferably no larger than 75 percent of the weight average particle length dimension and often no larger than 60 percent of the weight average particle length dimension.
118. The method of paragraph 117, wherein the weight average fiber length of either one or both of the batch of agglomerates and the batch of the bulk product is not smaller than 20 percent, preferably not smaller than 25 percent and often not smaller than 30 percent of the weight average particle length dimension.
119. The method of either one or paragraph 117 or paragraph 118, wherein the weight average fiber length is at least as large as an amount selected from the group consisting of 1 millimeter, 2 millimeters, 3 millimeters and 4 millimeters.
120. The method of any one of paragraphs 117-119, wherein the weight average fiber length of either one or both of the batch of agglomerates and the batch of the bulk product is not larger than an amount selected from the group consisting of 18 millimeters, 12 millimeters, 8 millimeters and 6 millimeters. One preferred range for the weight average fiber length of either one or both of the batch of agglomerates and the batch of the bulk product is from 3 millimeters to 8 millimeters, with another preferred range being from 4 millimeters to 6 millimeters.
121. The method of any one of paragraphs 117-120, wherein for either one or both of the batch of agglomerates and the batch of the bulk product:
at least 70 weight percent, preferably at least 75 weight percent, more preferably at least 80 weight percent and even more preferably at least 85 weight percent, of the reinforcing fibers in the batch have a fiber length in a range of from 0.5 times to 2 times the weight average fiber length of the batch.
122. The method of any one of paragraphs 117-121, wherein for either one or both of the batch of agglomerates and the batch of the bulk product:
at least 10 weight percent of the reinforcing fibers of the batch have a fiber length outside of a range of from 0.7 to 1.5 times the weight average fiber length.
123. The method of any one of paragraphs 117-122, wherein for either one or both of the batch of agglomerates and the batch of the bulk product:
at least 5 weight percent of the reinforcing fibers of the batch have a fiber length outside of a range of from 0.5 times to 2 times the weight average fiber length.
124. The method of any one of paragraphs 117-123, wherein for either one or both of the batch of agglomerates and the batch of the bulk product:
at least 15 weight percent of the reinforcing fibers of the batch have a fiber length outside of a range of from 0.8 times to 1.3 times the weight average fiber length.
125. The method of any one of paragraphs 117-124, wherein for either one or both of the batch of agglomerates and the batch of the bulk product:
the reinforcing fibers of the batch have a weight average aspect ratio of fiber length to fiber width of at least 100, preferably at least 500 and more preferably at least 1000.
126. The method of any one of paragraphs 117-125, wherein for either one or both of the batch of agglomerates and the batch of the bulk product:
the reinforcing fibers of the batch have a weight average aspect ratio of fiber length to fiber width of not larger than 10,000.
127. The method of any one of paragraphs 84-126, wherein for either one or both of the batch of agglomerates and the batch of the bulk product:
the reinforcing fibers have a weight average fiber width (e.g., diameter) in a range of from 0.5 microns to 100 microns.
128. The method of any one of paragraphs 1-127, wherein the reinforcing fibers are carbon fibers, and optionally the carbon fibers have a width (e.g., diameter) in a range of from 5 microns to 10 microns, and preferably from 5 microns to 7 microns.
129. The method of any one of paragraphs 1-128, wherein the reinforcing fibers are selected from the group consisting of glass fibers, mineral fibers, natural fibers, carbon nanotubes, polymeric fibers (e.g., aramid, polyamide or polyolefin fibers), metallic fibers and combinations thereof. Some possible polyolefin fibers include fibers of polypropylene, polyethylene, and propylene-ethylene copolymers, and including high performance polyolefin fibers, for example Dyneema® fibers (ultra-high molecular weight polyethylene) or Innegra fibers (high modulus polypropylene). Some possible mineral fibers include fibers of basalt, mineral wool or quartz. Some possible natural fibers include fibers of bamboo, flax, hemp, jute or kenaf. Some example metallic fibers include fibers of metal, metal alloys or intermetallics, with some more specific examples being fibers of steel or bronze.
130. The method of any one of paragraphs 1-129, wherein the reinforcing fibers comprise recycled fibers recovered from a fiber-reinforced composite.

The terms “comprising”, “containing”, “including” and “having”, and grammatical variations of those terms, are intended to be inclusive and nonlimiting in that the use of such terms indicates the presence of a stated condition or feature, but not to the exclusion of the presence also of any other condition or feature. The use of the terms “comprising”, “containing”, “including” and “having”, and grammatical variations of those terms in referring to the presence of one or more components, subcomponents or materials, also include and is intended to disclose the more specific embodiments in which the term “comprising”, “containing”, “including” or “having” (or the variation of such term) as the case may be, is replaced by any of the narrower terms “consisting essentially of” or “consisting of” or “consisting of only” (or any appropriate grammatical variation of such narrower terms). For example, a statement that something “comprises” a stated element or elements is also intended to include and disclose the more specific narrower embodiments of the thing “consisting essentially of” the stated element or elements, and the thing “consisting of” the stated element or elements. Examples of various features have been provided for purposes of illustration, and the terms “example”, “for example” and the like indicate illustrative examples that are not limiting and are not to be construed or interpreted as limiting a feature or features to any particular example. The term “at least” followed by a number (e.g., “at least one”) means that number or more than that number. The term at “at least a portion” of something means all or a portion of the thing that is less than all. The term “at least a part” of something means all or a part that is less than all. A “portion” or “part” of something includes a separated physical portion or part of the thing, with or without chemical, compositional or structural change or modification and with or without combination with one or more other things, and includes a chemical portion or part sourced from the thing, for example when the thing is a chemical precursor, that may have a different chemical composition or structure than the thing and may be in a composition, compound, molecule or structure together with one or more components not originally a part of the thing. The term “at least a majority” means all or a majority part that is less than all. Weight-base averages for properties of items (e.g., fibers, fiber-containing particles, or bulk products) as used herein are equivalent to mass-based averages of the properties of the items, and as will be appreciated will typically be different than number-based averages of the properties of the items (for example as a consequence of differences in mass content between individual items) and volumetric-based averages (for example as a consequence of variations in densities between individual items).

What is claimed is:

1. A method of making a bulk product comprising fiber-containing particles with reinforcing fibers held in a particle structure by a binder, the method comprising:
production processing, comprising:
(i) preparing agglomerates, comprising tumbling a process mixture comprising non-continuous reinforcing fibers and a binder material to form agglomerates including at least a portion of the non-continuous reinforcing fibers and at least a portion of the binder material, and wherein the agglomerates have a particle structure comprising:
a particle length dimension, being a maximum separation distance in a longitudinal direction between first and second longitudinal ends of the agglomerate;
a maximum particle width dimension transverse to the longitudinal direction at a longitudinal location between the first and second longitudinal ends; and
an aspect ratio equal to the particle length dimension divided by the maximum particle width dimension; and
(ii) subjecting the agglomerates to size classification to prepare a plurality of agglomerate fractions, the plurality of agglomerate fractions including at least a first agglomerate fraction having a first weight average particle length dimension and a second agglomerate fraction having a second weight average particle length dimension, wherein the first weight average particle length dimension is smaller than the second weight average particle length dimension; and
(iii) processing at least a portion of the agglomerates of the first agglomerate fraction to provide fiber-containing particles with the particle structure for inclusion in a bulk product; and
reprocessing the non-continuous fibers and the binder material of at least a portion of the second agglomerate fraction, the reprocessing comprising:
(a) subjecting at least a portion, of the agglomerates of the second agglomerate fraction to length reduction processing to reduce the length of at least a portion of the non-continuous reinforcing fibers of the second agglomerate fraction to prepare reprocessed non-continuous reinforcing fibers; and
(b) subjecting to a reprocessing occurrence of the production processing at least a portion of the reprocessed non-continuous reinforcing fibers from the second agglomerate fraction and at least a portion of the binder material from the second agglomerate fraction in the process mixture of the reprocessing occurrence of the production processing.

2. The method of claim 1, wherein the second weight average particle length dimension is at least 1.25 times as large as the first weight average particle length dimension and the second weight average particle length dimension is not larger than 10 times as large as the first weight average particle length dimension.

3. The method of either one of claim 1 or claim 2, wherein the first weight average particle length is in a range of from 3 millimeters to 40 millimeters.

4. The method of any one of claims 1-3, wherein the first agglomerate fraction comprises a first weight average aspect ratio and the second agglomerate fraction comprises a second weight average aspect ratio, and the second weight average aspect ratio is at least 1.25 times as large as the first weight average aspect ratio and the second weight average aspect ratio is not larger than 10 times as large as the first weight average aspect ratio.

5. The method of any one of claims 1-4, wherein the process mixture of the reprocessing occurrence of the production processing comprises a weight ratio of the binder material to the reprocessed non-continuous reinforcing fibers that is within a range of from 0.9 to 1.1 a weight ratio of the binder material to the non-continuous fibers in the second agglomerate fraction.

6. The method of any one of any one of claims 1-5, wherein the process mixture of the reprocessing occurrence of the production processing comprises a quantity of the reprocessed non-continuous reinforcing fibers equal to at least 90 mass percent of the mass of the non-continuous reinforcing fibers of the second agglomerate fraction and a quantity of the binder material equal to at least 90 mass percent of the mass of the binder material of the second agglomerate fraction.

7. The method of any one of claims 1-6, wherein:
the process mixture of the production processing comprises water, in addition to the non-continuous reinforcing fibers and the binder material, to prepare the agglomerates comprising water from the process mixture;
the process mixture of the reprocessing occurrence of the production processing comprises water from the second agglomerate fraction;
the at least a portion of the second agglomerate fraction subjected to the length reduction processing comprises water at a concentration in a range of from 5 weight percent to 50 weight percent.

8. The method of claim 7, wherein the process mixture of the reprocessing occurrence of the production processing comprises water only from the second agglomerate fraction.

9. The method of claim 7, wherein the process mixture of the reprocessing occurrence of the production processing comprises added water in addition to the water from the second agglomerate fraction.

10. The method of any one of claims 1-9, wherein the non-continuous reinforcing fibers in the process mixture of the reprocessing occurrence of the production processing comprises only the reprocessed non-continuous reinforcing fibers prepared from the at least a portion of the second agglomerate fraction as the non-continuous reinforcing fibers in the process mixture.

11. The method of any one of claims 1-10, wherein the binder material in the process mixture of the reprocessing occurrence of the production processing comprises only the binder material from the at least a portion of the second agglomerate fraction.

12. The method of any one of claims 1-9, wherein the non-continuous reinforcing fibers in the process mixture of the reprocessing occurrence of the production processing comprise non-continuous reinforcing fibers other than the reprocessed non-continuous reinforcing fibers prepared from the at least a portion of the second fraction.

13. The method of claim 12, wherein the other non-continuous reinforcing fibers comprise non-continuous reinforcing fibers provided to the reprocessing occurrence of the production processing in a non-continuous fiber feed in dry form.

14. The method of any one of claims 1-13, comprising subjecting to an occurrence of the reprocessing the non-continuous fibers and the binder material of at least a portion of a said second agglomerate fraction prepared during the reprocessing occurrence of the production processing.

15. The method of any one of claims 1-14, wherein the plurality of agglomerate fractions include a third agglomerate fraction having a third weight average particle length dimension and the third weight average particle length dimension is larger than the first weight average particle dimension and smaller than the second weight average particle dimension.

16. The method of claim 15, comprising subjecting at least a portion of the third agglomerate fraction to the reprocessing.

17. The method of any one of claims 1-16, comprising an initial occurrence of the production processing in which at least a portion of the non-continuous fibers for the process mixture are provided to the initial occurrence of the production processing in a non-continuous fiber feed in dry form; and
wherein the method comprises preliminary processing of reinforcing fibers to prepare the non-continuous fiber feed.

18. The method of claim 17, wherein the preliminary processing comprises:
size classifying a mixture of non-continuous reinforcing fibers to prepare a plurality of fiber fractions including at least a first fiber fraction having a first weight average fiber length and a second fiber fraction having a second weight average fiber length, wherein the second weight average fiber length is larger than the first weight average fiber length; and
preparing the non-continuous fiber feed to include at least a portion of non-continuous reinforcing fibers of the first fiber fraction.

19. The method of claim 18, wherein the second weight average fiber length is at least 1.25 times as large as the first weight average fiber length and the second weight average fiber length is not larger than 10 times as large as the first weight average fiber length.

20. The method of either one of claim 18 or claim 19, wherein the first weight average fiber length is at least 1 millimeter; and
wherein the first weight average fiber length is not larger than 18 millimeters.

21. The method of any one of claims 18-20, wherein the plurality of fiber fractions include a third fiber fraction having a third weight average fiber length, wherein the third weight average fiber length is smaller than the first weight average fiber length.

22. The method of claim 21, comprising excluding at least a portion of the third fiber fraction from the non-continuous fiber feed and from the agglomerates.

23. The method of any one of claims 18-22, wherein at least a portion of the first fiber fraction forms at least a part of the non-continuous fiber feed and without fiber modification after the size classifying and before inclusion in the non-continuous fiber feed.

24. The method of any one of claims 18-23, comprising subjecting at least a portion of the second fiber fraction to fiber length reduction to prepare reduced-length fibers and preparing the non-continuous fiber feed to include at least a portion of the reduced-length fibers.

25. The method of claim 24, comprising recycling at least a portion of the reduced-length fibers to be included in the mixture of non-continuous reinforcing fibers subjected to the size classifying.

26. The method of claim 17, wherein the preliminary processing comprises:
increasing longitudinal alignment of reinforcing fibers relative to each other to prepare an aligned fiber feed; and
preparing the non-continuous fiber feed to include at least a portion of the reinforcing fibers of the aligned fiber feed.

27. The method of claim 26, wherein the preparing the non-continuous fiber feed comprises, prior to the increasing longitudinal alignment of the reinforcing fibers, subjecting the reinforcing fibers to an upstream length reduction operation to reduce weight average length of the reinforcing fibers prior to the increasing longitudinal alignment.

28. The method of either one of claim 26 or claim 27, wherein the preparing the non-continuous fiber feed comprises subjecting the reinforcing fibers in the aligned fiber feed to a downstream length reduction operation to reduce weight average length of the reinforcing fibers.

29. The method of claim 28, wherein the preparing the non-continuous fiber feed comprises:
size classifying a mixture of non-continuous reinforcing fibers from the downstream length reduction operation to prepare a plurality of fiber fractions including at least a first fiber fraction having a first weight average fiber length and a second fiber fraction having a second weight average fiber length, wherein the second weight average fiber length is larger than the first weight average fiber length; and
preparing the non-continuous fiber feed to include at least a portion of non-continuous reinforcing fibers of the first fiber fraction.

30. The method of either one of claim 28 or claim 29, wherein the increasing longitudinal alignment of the reinforcing fibers increases longitudinal alignment of the reinforcing fibers relative to a machine direction of travel of the reinforcing fibers toward the downstream length reduction operation.

31. The method of any one of claims 26-30, wherein the increasing longitudinal alignment of the reinforcing fibers comprises increasing the longitudinal alignment of the reinforcing fibers from a first alignment to a second alignment, wherein in the second alignment the reinforcing fibers are more aligned with a machine direction of conveyance of the reinforcing fibers; and
wherein in the first alignment at least 30 length percent of the reinforcing fibers have a longitudinal orientation at an alignment angle between 45° and 90° relative to the machine direction of conveyance and in the second alignment not more than 20 length percent of the reinforcing fibers have a longitudinal orientation at an alignment angle between 45° and 90° relative to the machine direction of conveyance.

32. The method of any one of claims 26-31, wherein the preparing the fiber feed comprises, after the increasing longitudinal alignment:
size classifying the reinforcing fibers to prepare a plurality of fiber fractions including at least a first fiber fraction having a first weight average fiber length and a second fiber fraction having a second weight average fiber length, wherein the second weight average fiber length is larger than the first weight average fiber length; and
preparing the non-continuous fiber feed to include at least a portion of non-continuous reinforcing fibers of the first fiber fraction.

33. The method of any one of claims 17-32, wherein a preliminary fiber feed to the preliminary processing comprises recycled reinforcing fibers recovered from composite material.

34. The method of any one of claims 1-33, wherein the tumbling comprises rotational tumbling, and
the preparing agglomerates comprises disposing the reinforcing fibers and the binder material in a process vessel and the rotational tumbling comprises rotating the process vessel containing the reinforcing fibers and the binder material.

35. The method of any one of paragraphs 1-34, wherein the preparing agglomerates comprises:
during the tumbling, forming the agglomerates as particles with a particle structure, wherein the particle structure comprises:
a particle length dimension, being a maximum separation distance in a longitudinal direction between first and second longitudinal ends of the particle;
a maximum particle width dimension transverse to the longitudinal direction at a longitudinal location between the first and second longitudinal ends; and
an aspect ratio equal to the particle length dimension divided by the maximum particle width dimension; and
recovering a batch of agglomerates comprising at least a portion of the agglomerates as particles of the batch; and
wherein the method further comprises processing at least a portion of the batch of agglomerates to prepare a batch of bulk product with a plurality of fiber-containing particles having the particle structure.

36. The method of claim 35, wherein for either one or both of the batch of agglomerates and the batch of the bulk product:
at least 25 weight percent the particles of the batch have a dual-tapered shape comprising a first tapered portion tapering in the longitudinal direction away from the longitudinal location toward the first longitudinal end and a second tapered portion tapering in the longitudinal direction away from the longitudinal location toward the second longitudinal end.

37. The method of any one of claim 36, wherein for each of the batch of agglomerates and the batch of the bulk product, the batch comprises:
a weight average particle length dimension, being an average on a weight basis of the particle length dimensions of the particles of the batch; and
a weight average aspect ratio, being an average on a weight basis of the aspect ratios of the particles of the batch;
and wherein for either one or both of the batch of agglomerates and the batch of the bulk product:
the weight average particle length dimension is in a range of from 3 millimeters to 40 millimeters; and
the weight average aspect ratio is in a range of from 1.5 to 6.

38. The method of any one of claims 1-37, wherein the reinforcing fibers are carbon fibers.
